(19) United States
(12) Patent Application Publication
(10) Pub. No.: US 2026/0051609 A1
(43) Pub. Date: Feb. 19, 2026

(54) Secondary Battery

(71) Applicant: LG Energy Solution, Ltd., Seoul (KR)

(72) Inventors: Hyun Hee Lee, Daejeon (KR); Seung Hyun Noh, Daejeon (KR); Sang Joon Park, Daejeon (KR); Young Jong Son, Daejeon (KR); Hyun Jung Suh, Daejeon (KR)

(73) Assignee: LG Energy Solution, Ltd., Seoul (KR)

(21) Appl. No.: 19/297,716

(22) Filed: Aug. 12, 2025

(30) Foreign Application Priority Data
Aug. 14, 2024 (KR) 10-2024-0108804
Sep. 10, 2024 (KR) 10-2024-0123535
Mar. 27, 2025 (KR) 10-2025-0039745
Aug. 6, 2025 (KR) 10-2025-0107913
Aug. 11, 2025 (KR) 10-2025-0110816
Aug. 11, 2025 (KR) 10-2025-0110953
Aug. 11, 2025 (KR) 10-2025-0110955

(51) Int. Cl. H01M 50/342; H01M 50/103; H01M 50/15

(52) U.S. Cl. CPC H01M 50/3425; H01M 50/103; H01M 50/15

(57) ABSTRACT

A secondary battery including a casing having an internal space, an electrode assembly inserted into the casing and configured to perform charging and discharging, a cap plate coupled to the casing, and a vent structure formed in the casing or the cap plate is provided. The vent structure includes a plurality of lateral scores and a connection score connecting the lateral scores, and the connection score includes at least one curved line formed of a curve. The vent structure may include first and second convex portions that are disposed adjacent to each other and protrude with the connection score located between the first and second convex portions.

### CROSS-REFERENCE TO RELATED APPLICATIONS

The present application claims the benefit of foreign priority to Korean Patent Application Nos. 10-2024-0108804, filed Aug. 14, 2024, 10-2024-0123535, filed Sep. 10, 2024, 10-2025-0039745, filed Mar. 27, 2025, 10-2025-0107913, filed Aug. 6, 2025, 10-2025-0110953, filed Aug. 11, 2025, 10-2025-0110955, filed Aug. 11, 2025, and 10-2025-0110816, filed Aug. 11, 2025 in the Republic of Korea, the entire disclosures of which are incorporated by reference herein.

### TECHNICAL FIELD

The present disclosure relates to a secondary battery that is chargeable and dischargeable.

### BACKGROUND

Recently, as the demand for portable electronic devices such as notebook computers, video cameras, and mobile phones has rapidly increased and the development of electric vehicles, energy storage batteries, robots, satellites, and the like has been actively promoted, intensive research has been conducted on high-performance secondary batteries capable of repeated charging and discharging.

Currently commercialized secondary batteries include nickel-cadmium batteries, nickel-metal hydride batteries, nickel-zinc batteries, lithium secondary batteries, and the like. Among the secondary batteries listed above, lithium secondary batteries are attracting attention due to advantages such as allowing flexible charging and discharging owing to negligible memory effect compared to nickel-based secondary batteries, exhibiting a significantly low self-discharge rate, and having a relatively high energy density.

Such lithium secondary batteries mainly use a lithium-based oxide and a carbon material as a positive electrode active material and a negative electrode active material, respectively. In addition, the lithium secondary battery includes a positive electrode plate and a negative electrode plate on which the positive electrode active material and the negative electrode active material are respectively applied, an electrode assembly in which the positive electrode plate and the negative electrode plate are located with a separator interposed therebetween, and an external housing that seals and accommodates the electrode assembly together with an electrolyte.

Lithium secondary batteries may be classified, according to the shape of a battery casing, into a can-type secondary battery, in which an electrode assembly is embedded in a metal can, and a pouch-type secondary battery in which an electrode assembly is embedded in a pouch formed of an aluminum laminate sheet. The can-type secondary battery may also be classified into a cylindrical secondary battery and a prismatic secondary battery according to the shape of the metal can.

In the case of the prismatic secondary battery, a vent structure that opens in response to an increase in internal pressure is provided. The vent structure is required to open precisely at a preset pressure in order to enhance the safety of the secondary battery.

### SUMMARY

The present disclosure is directed to providing a secondary battery capable of efficiently and reliably relieving an increase in internal pressure.

A secondary battery according to one aspect of the present disclosure may include a casing, an electrode assembly accommodated in the casing, a cap plate coupled to the casing, and a vent structure located along the casing or the cap plate. The vent structure may include lateral scores and a connection score connecting the lateral scores, and the connection score may include a curved line following a curved path along a length direction of the connection score. A lateral score may include a curved portion along its length.

According to one aspect of the present disclosure, the curved line may extend in an arc shape having a first curvature radius, and a curved portion of a lateral score defining an arc shape and having a second curvature radius.

According to one aspect of the present disclosure, the first curvature radius may be different from the second curvature radius.

According to one aspect of the present disclosure, the first curvature radius may be greater than the second curvature radius.

According to one aspect of the present disclosure, the first curvature radius may be 1.1 times to 5.5 times the second curvature radius.

According to one aspect of the present disclosure, a lateral score may include a first linear portion connected to a first end of the curved portion and extending in a straight line, and a second linear portion connected to a second end of the curved portion and extending in a straight line.

According to one aspect of the present disclosure, the curved line may include a first curved line and a second curved line, and the first curved line and the second curved line may be bowed out in opposite directions.

According to one aspect of the present disclosure, the curvature radius of the first curved line may equal the curvature radius of the second curved line.

According to one aspect of the present disclosure, the connection score may have an inflection point at which the first curved line and the second curved line meet. An inclination angle of an acute angle formed by a tangent line at the inflection point and a longitudinal axis of the vent structure may range from 5 degrees to 60 degrees.

According to one aspect of the present disclosure, a first distance that is a maximum distance between the connection score and a longitudinal axis of the vent structure may be 0.05 times to 0.4 times a second distance that is a maximum distance between the longitudinal axis and the lateral scores.

According to one aspect of the present disclosure, the lateral scores may include a first lateral score and a second lateral score, and the first lateral score and the second lateral score may surround 50% to 90% of the connection score.

According to one aspect of the present disclosure, the vent structure may include an elongated protrusion extending longitudinally along the connection score and protruding convexly from the vent structure, and the connection score may be positioned on the elongated protrusion.

According to one aspect of the present disclosure, the vent structure may include elongated protrusions extending longitudinally along respective laterals scores and protruding convexly from the vent structure, and the lateral scores may be positioned on respective elongated protrusions.

According to one aspect of the present disclosure, the vent structure may include a first elongated groove extending longitudinally along the connection score and recessed in a concave shape within the vent structure, and second elongated grooves extending in longitudinal directions of the respective lateral scores and recessed in a concave shape within the vent structure. The connection score may be positioned in the first elongated groove, and the lateral scores may be positioned in the respective second elongated grooves.

According to one aspect of the present disclosure, the vent structure may include a first recess encompassing the lateral scores and the connection score, and a second recess positioned in a bottom of the first recess and extending longitudinally along the connection score. The lateral scores may be positioned in the first recess, and the connection score may be positioned in the second recess.

According to one aspect of the present disclosure, the vent structure may be located in the cap plate, a bottom surface of the casing, or a side surface of the casing.

According to one aspect of the present disclosure, the curved line may include a plurality of curvature radii.

According to one aspect of the present disclosure, a longitudinal axis of the vent structure may extend parallel to a longitudinal direction of the cap plate.

According to one aspect of the present disclosure, a longitudinal axis of the vent structure may extend in a direction intersecting a longitudinal direction of the cap plate.

According to one aspect of the present disclosure, the vent structure may include a first convex portion and a second convex portion that are adjacent to each other and protrude outward from the vent structure, with the connection score located between the first and second convex portions.

According to one aspect of the disclosure, an inclination angle formed between a tangent line of the first convex portion or the second convex portion where the convex portion connects to the connection score and a plane parallel to the cap plate may be in a range from 1 degree to 20 degrees.

According to one aspect of the disclosure, a first tangential angle formed between a first tangent line at an edge of the first convex portion adjacent to the connection score and a virtual reference plane parallel to the cap plate may be smaller than a second tangential angle formed between a second tangent line at an edge of the first convex portion adjacent to one of the lateral scores and the virtual reference plane.

According to one aspect of the disclosure, the second tangential angle ranges from 1.1 times to 3.5 times the first tangential angle.

According to one aspect of the disclosure, the connection score may include an inflection point at which the first curved line and the second curved line meet, a first reference point at which the first curved line may form a maximum distance from a reference line extending in a longitudinal direction of the vent structure at a center in a width direction of the vent structure, and a second reference point at which the second curved line may form a maximum distance from the reference line. A first inclination angle formed between a tangent line at an outer edge of the first convex portion in the width direction at the first reference point and a virtual reference plane parallel to the cap plate, and a second inclination angle formed between a tangent line at an outer edge of the first convex portion in the width direction at the second reference point and the reference plane, may each be greater than a third inclination angle formed between a tangent line at an outer edge of the first convex portion in the width direction at the inflection point and the reference plane

According to one aspect of the disclosure, the first inclination angle and the second inclination angle may each be in a range of from 1.2 times to 2.5 times the third inclination angle.

According to one aspect of the disclosure, the connection score, the plurality of lateral scores, the first convex portion, and the second convex portion may be formed on an outer surface of the vent structure that faces away from an outer side of the casing.

According to one aspect of the disclosure, the connection score, the plurality of lateral scores, the first convex portion, and the second convex portion may be formed on an inner surface of the vent structure that faces inside the casing.

According to one aspect of the disclosure, the first convex portion and the second convex portion may be formed on an outer surface of the vent structure that faces away from an outer side of the casing, and the connection score and the plurality of lateral scores may be formed on an opposite inner surface of the vent structure that faces inside the casing.

According to one aspect of the disclosure, the first convex portion and the second convex portion may be formed on an inner surface of the vent structure that faces inside the casing, and the connection score and the plurality of lateral scores may be formed on an opposite outer surface of the vent structure that faces away from an outer side of the casing.

According to a further aspect of the present disclosure, the vent structure may further include a support rib protruding from a position outside each of the lateral scores and surrounding the corresponding lateral score.

According to an aspect of the present disclosure, the vent structure may satisfy Equation 1 as follows:

$$\frac{L 22}{L 11} = AL \times \frac{L 21}{L 12} , \qquad ( Equation 1 )$$

where L11 is a length of the cap plate, L12 is a width of the cap plate, L21 is a length of a major axis of the vent structure being a longest line segment passing through the center of the vent structure and connecting outer edges of the vent structure, L22 is a length of a minor axis of the vent structure being a longest line segment extending in a length direction of the cap plate passing through the center of the vent structure and connecting outer edges of the vent structure, the major axis extends in a direction intersecting the longitudinal direction of the cap plate, and where 0.08≤AL≤0.36.

According to an aspect of the present disclosure, L22 may range from 0.03 times to 0.08 times L11.

According to an aspect of the present disclosure, the vent structure may include a connection score extending in a curved line, and a length of the connection score ranges from 0.9 times to 1.3 times the length of the major axis L21.

According to an aspect of the present disclosure, the length of the connection score may be greater than L21.

According to an aspect of the present disclosure, the vent structure may satisfy Equation 4 as follows:

$$R 11 = A \times R 12 + G 11 , \qquad ( Equation 4 )$$

wherein R11 is a radius of the first curved line,
R12 is a radius of the second curved line,
G11 is a maximum distance between the major axis and the connection score, and
where 1.3≤A≤4.5.

A secondary battery according to an additional aspect of the present disclosure may include a casing including an internal space, an electrode assembly accommodated in the casing and configured to be charged and discharged, a cap plate coupled to the casing; and a vent structure located along the casing or the cap plate. The vent structure may include lateral scores and a connection score connecting the lateral scores, and the connection score may include at least one curved line following a curved path along a length direction of the connection score.

A secondary battery according to a further aspect of the present disclosure may include a casing including an internal space, an electrode assembly accommodated in the casing and configured to be charged and discharged, a cap plate coupled to the casing; and a vent structure located along the casing or the cap plate. The vent structure may include lateral scores and a connection score connecting the lateral scores, and a lateral score may include a curved portion along a length direction of the at least one lateral score.

According to a further aspect of the present disclosure, the connection score may include a one bend along its length direction.

According to a further aspect of the present disclosure, the connection score may include two bends along the length direction of the connection score and the bends may bend out in opposing directions.

According to a further aspect of the present disclosure, the connection score may be straight along a length between the lateral scores.

### BRIEF DESCRIPTION OF THE DRAWINGS

The following drawings attached to this specification illustrate preferred aspects of the present disclosure, and help to further understand the technical spirit of the present disclosure along with the aforementioned contents of the disclosure. Accordingly, the present disclosure should not be construed as being limited to only contents described in such drawings.

FIG. 1 is a perspective view illustrating a secondary battery according to a first aspect of the present disclosure.

FIG. 2 is a sectional view taken along line II-II of FIG. 1.

FIG. 3 is a top plan view of the secondary battery according to the first aspect of the present disclosure.

FIG. 4 is a plan view illustrating a vent structure according to the first aspect of the present disclosure.

FIG. 5 is a sectional view taken along line V-V of FIG. 3.

FIG. 6 is a diagram partially illustrating a connection notch according to the first aspect of the present disclosure.

FIG. 7 is a perspective view illustrating the vent structure that is in an open state according to the first aspect of the present disclosure.

FIG. 8 is a perspective view illustrating a vent structure according to a second aspect of the present disclosure.

FIG. 9 is a sectional view taken along line IX-IX of FIG. 8.

FIG. 10 is a sectional view illustrating a vent structure according to a third aspect of the present disclosure.

FIG. 11 is a perspective view illustrating a vent structure according to a fourth aspect of the present disclosure.

FIG. 12 is a sectional view taken along line XII-XII of FIG. 11.

FIG. 13 is a plan view illustrating a vent structure according to a fifth aspect of the present disclosure.

FIG. 14 is a perspective view illustrating the vent structure according to the sixth aspect of the present disclosure.

FIG. 15 is a sectional view taken along line A2-A2 of FIG. 14.

FIG. 16 is a sectional view taken along line A3-A3 of FIG. 14.

FIG. 17 is a sectional view taken along line A4-A4 of FIG. 14.

FIG. 18 is a sectional view taken along line A5-A5 of FIG. 14.

FIG. 19 is a perspective view illustrating a vent structure according to a seventh aspect of the present disclosure.

FIG. 20 is a sectional view taken along line A6-A6 of FIG. 19.

FIG. 21 is a bottom perspective view illustrating a vent structure according to a eighth aspect of the present disclosure.

FIG. 22 is a sectional view taken along line A7-A7 of FIG. 21.

FIG. 23 is a sectional view illustrating a portion of a vent structure in which a connection notch and a first side notch are located, according to a ninth aspect of the present disclosure.

FIG. 24 is a sectional view illustrating a portion of the vent structure in which the connection notch and a second side notch are located, according to the ninth aspect of the present disclosure.

FIG. 25 is a sectional view illustrating a portion of a vent structure in which a connection notch and a first side notch are located, according to a tenth aspect of the present disclosure.

FIG. 26 is a sectional view illustrating a portion of the vent structure in which the connection notch and a second side notch are located, according to the tenth aspect of the present disclosure.

FIG. 27 is a perspective view illustrating a secondary battery according to a eleventh aspect of the present disclosure.

FIG. 28 is a diagram illustrating a vent protection film according to the sixth aspect of the present disclosure.

FIG. 29 is a sectional view taken along line XVI-XVI of FIG. 27.

FIG. 30 is a perspective view illustrating a secondary battery according to a twelfth aspect of the present disclosure.

FIG. 31 is a perspective view illustrating a secondary battery according to an thirteenth aspect of the present disclosure.

FIG. 32 is a top plan view illustrating a secondary battery according to a fourteenth aspect of the present disclosure.

FIG. 33 is a plan view illustrating vent structure of FIG. 32.

FIG. 34 is a plan view illustrating a secondary battery according to a fifteenth aspect of the present disclosure.

### DETAILED DESCRIPTION

Since the present disclosure may be modified in various forms, and may have various aspects, particular aspects will be illustrated in the accompanying drawings and described in detail with reference to the drawings. However, this is not intended to limit the present disclosure to particular modes of practice, and it is to be appreciated that all changes, equivalents, and substitutes that do not depart from the spirit and technical scope of the present disclosure are encompassed in the present disclosure.

The terminology used herein is for the purpose of describing particular aspects only and is not intended to limit the present disclosure. In the present disclosure, the singular forms are intended to include the plural forms as well, unless the context clearly indicates otherwise. It will be further understood that the terms “comprise”, “include”, “have”, etc. when used in this specification, are intended to specify the presence of stated features, integers, steps, operations, elements, components, and/or combinations of them but do not preclude the presence or addition of one or more other features, integers, steps, operations, elements, components, and/or combinations thereof.

Hereinafter, aspects of the present disclosure will be described in detail with reference to the accompanying drawings. It should be noted that like reference numerals refer to like elements throughout the attached drawings. Details of well-known configurations and functions may be omitted to avoid unnecessarily obscuring the gist of the present disclosure. For the same reason, in the accompanying drawings, some elements are enlarged, omitted, or depicted schematically.

Hereinafter, a secondary battery according to an aspect of the present disclosure will be described.

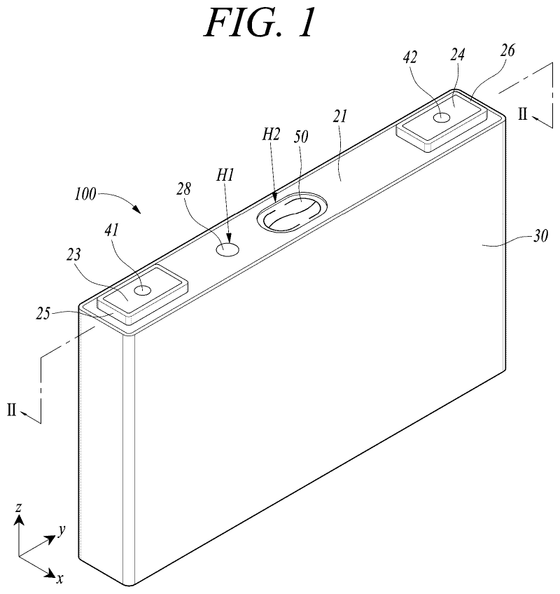

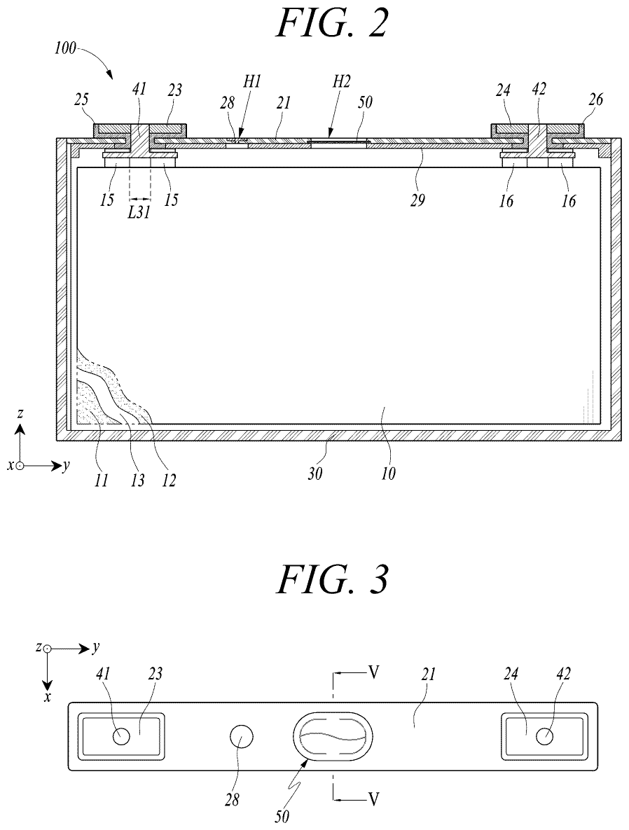

FIG. 1 is a perspective view illustrating a secondary battery according to a first aspect of the present disclosure. FIG. 2 is a sectional view taken along line II-II of FIG. 1. FIG. 3 is a top plan view of the secondary battery according to the first aspect of the present disclosure.

Referring to FIGS. 1 to 3, a secondary battery 100 according to the present aspect may include an electrode assembly 10 including one or more positive electrode(s) 11 and one or more negative electrode(s) 12, a casing 30 that accommodates the electrode assembly 10, a cap plate 21 that couples to the casing 30, terminals 23 and 24 provided on the cap plate 21, an upper insulator 29 placed between the cap plate 21 and the electrode assembly 10, and a vent structure 50 provided in the cap plate 21.

The electrode assembly 10 may perform charging and discharging, and may be implemented in various forms such as an all-solid-state electrode assembly, a lithium-ion electrode assembly, or a sodium-ion electrode assembly.

The electrode assembly 10 may include one or more separator(s) 13 interposed between a positive electrode 11 and a negative electrode 12. One or more positive electrode(s) 11, the one or more separator(s) 13, and one or more negative electrode(s) 12 may be formed in a stacked structure, or may be provided in a wound structure in a jelly-roll form.

In addition, the electrode assembly 10 may have a structure in which one or more positive electrode(s) 11 and one or more negative electrode(s) 12 are alternately inserted between portions of a separator 13 bent in a zigzag shape.

The separator may be any material such as an electrically non-conductive polymer or ceramic material which keeps positive and negative electrodes apart while allowing permeation of electrolyte and/or the transport of charge carriers. The electrode assembly 10 may also be implemented in various forms such as an all-solid-state type that has no distinct separator and where a solid electrolyte may act as both an electrolyte and a separator.

Each of the positive electrode 11 and the negative electrode 12 may include a coated portion, which is a region where an active material is applied onto a metal foil, and an uncoated portion where the active material is not applied. An electrode may also be formed without any active material coating present during initial construction of the electrode assembly 10 of battery 100 such as an anodeless arrangement. A positive uncoated portion 15 may protrude from a side end of the positive electrode 11, and a negative uncoated portion 16 may protrude from a side end of the negative electrode 12. The positive uncoated portion 15 and the negative uncoated portion 16 may protrude in the same direction, and may protrude in a direction toward the cap plate 21 (in a z-axis direction), or the positive uncoated portion 15 and the negative portion 16 may protrude in different directions.

The positive uncoated portion 15 and the negative uncoated portion 16 may each be formed in a tab shape, and may be spaced apart from each other in a width direction (y-axis direction) of the casing 30. The tabs may be formed as a whole with the electrode collector or include a foil tab that can be formed by notching the electrode collector. In other aspects, the tab may be a member that is separately coupled to the electrode assembly. Positive uncoated portions 15 and negative uncoated portions 16 may be stacked in a thickness direction (x-axis direction) of the casing 30.

Furthermore, the positive uncoated portion 15 may be connected to the first terminal 23 via a current collector 41. The negative uncoated portion 16 may be connected to the second terminal 24 by a current collector 42.

Separator 13 is disposed between the positive electrode 11 and the negative electrode 12. Separator 13 prevents a short circuit between the positive electrode 11 and the negative electrode 12 and allows movement of ions. The separator may be any material, such as an electrically non-conductive polymer or ceramic material, which keeps positive and negative electrodes apart while allowing permeation of electrolyte and/or the transport of the ions or charge carriers. In the case where the secondary battery 100 is implemented as an all-solid-state battery, a solid electrolyte may be positioned between the positive electrode 11 and the negative electrode 12 instead of the separator 13. An all-solid-state battery may have no distinct separator and a solid electrolyte may function as both an electrolyte and a separator.

The casing 30 may have a box shape with an internal space capable of accommodating the electrode assembly 10. The casing 30 may be formed in various shapes such as a prismatic shape or a cylindrical shape. The single electrode assembly 10 may be inserted into the casing 30, or a plurality of electrode assemblies 10 may be inserted into the casing 30.

An electrolyte may be accommodated together with the electrode assembly 10 in the casing 30. The electrolyte may be in a liquid, solid, or gel phase.

The cap plate 21 may be formed of a plate covering an opening of the casing 30, and may have a shape corresponding to that of the opening of the casing 30. The cap plate 21 may be fixed to the casing 30 by welding.

An electrolyte injection hole H1 for injecting an electrolyte and a vent hole H2 in which a vent structure 50 is installed may be formed in the cap plate 21. A sealing plug 28 that seals the electrolyte injection hole H1 may be provided in the electrolyte injection hole H1. The vent structure 50 formed in the vent hole H2 may be configured to open at a pressure equal to or greater than a preset predetermined pressure.

The upper insulator 29 may be placed under the cap plate 21. The upper insulator 29 may be formed of a plate parallel to the cap plate 21, and may extend in a longitudinal direction (y-axis direction) of the cap plate 21.

The terminals 23 and 24 may be coupled to the cap plate 21. One or two terminals 23 and 24 may be provided on the cap plate 21. In the case where two terminals 23 and 24 are provided on the cap plate 21, the first terminal 23 may function as a positive electrode terminal, and the second terminal 24 may function as a negative electrode terminal. In the case where only one terminal is provided on the cap plate 21, the casing 30 may serve as the negative electrode through electrical connection. The electrode terminals may also be reversed.

The first terminal 23 and the second terminal 24 may each be formed in a plate shape. Although any shape that allows for an effective electrical connection to an external load may be used including, but not limited to, a rod, tube, stud, post, button, or pin and the first terminal 23 and the second terminal 24 may be bent or straight. A gasket 25 for insulation may be provided between the first terminal 23 and the cap plate 21. A gasket 26 for insulation may also be provided between the second terminal 24 and the cap plate 21. The gaskets 25 and 26 may extend downward to be also located between the current collectors 41 and 42 and the cap plate 21. The gaskets 25 and 26 may be formed as a single component or may be divided into a plurality of components.

The first terminal 23 may be electrically connected to the positive uncoated portion 15 via the first current collector 41. The second terminal 24 may be electrically connected to the negative uncoated portion 16 via the second current collector 42.

A hole into which a connection post of the first current collector 41 or the second current collector 42 is inserted may be formed in a central portion of each of the first terminal 23 and the second terminal 24.

The electrode assembly 10 may include two positive uncoated portion arrays having the same polarity. The positive uncoated portion arrays may be arranged so as not to overlap in the width direction (y-axis direction) and the thickness direction (x-axis direction) of the electrode assembly 10. The positive uncoated portion arrays may be welded to the first current collector 41.

Furthermore, the electrode assembly 10 may include two negative uncoated portion arrays having the same polarity. The negative uncoated portion arrays may be arranged so as not to overlap in the width direction (y-axis direction) and the thickness direction (x-axis direction) of the electrode assembly 10. The negative uncoated portion arrays may be welded to the second current collector 42.

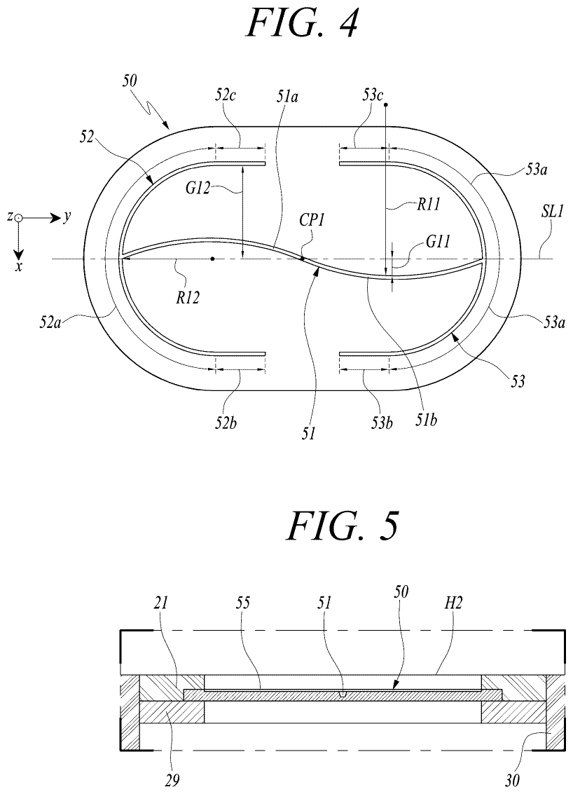

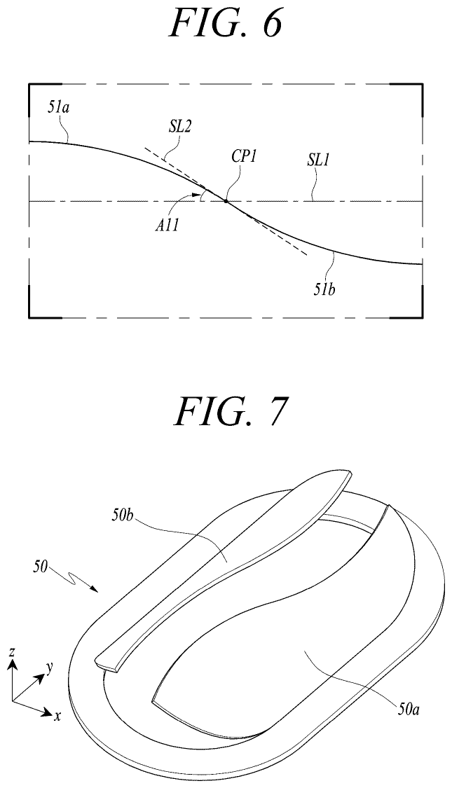

FIG. 4 is a plan view illustrating the vent structure according to the first aspect of the present disclosure. FIG. 5 is a sectional view taken along line V-V of FIG. 3. FIG. 6 is a diagram partially illustrating a connection notch according to the first aspect of the present disclosure. FIG. 7 is a perspective view illustrating the vent structure that is in an open state according to the first aspect of the present disclosure.

Referring to FIGS. 4 to 7, the vent structure 50 is formed in a plate shape, and is configured to open at a pressure equal to or greater than a preset predetermined pressure. The vent structure 50 may be formed as an oval-shaped, or “track”-shaped, plate in which two arcs are connected by straight lines. However, the present disclosure is not limited thereto and other shapes including round and/or straight sides can be used such as square, rectangle, polygon, or circle.

The vent structure 50 may extend a predetermined length in a longitudinal direction (y-axis direction) of the cap plate 21. The vent structure 50 may have a major axis, or longitudinal axis, direction corresponding to a longitudinal direction thereof and a minor axis direction corresponding to a width direction thereof. The major axis direction may extend parallel to the longitudinal direction (y-axis direction) of the cap plate 21.

In addition, the vent structure 50 may be fixed to the cap plate 21 by welding or any other method of securely fixing the vent structure 50 to the cap plate 21. The vent structure 50 may be fixed to a lower surface of the cap plate 21, and may be fixed to an upper surface of the cap plate 21. The vent structure may be sandwiched between upper and lower portions of the cap plate to fix the vent structure 50 to the cap plate 21.

The vent structure 50 may include scores 51, 52, and 53 which create weakened portions of the vent material with respect to an adjacent or surrounding portion. The scores 51, 52, and 53 may be in the form of notches 51, 52, and 53 having a groove shape in the surface of the vent material and/or the scores may be formed by weakening the vent material such as chemically, thermally, by compression, and/or with radiation. The vent structure aspects of 50, 210, 220, 230, and 240 will hereinafter be further described in terms of the use of notches for scoring the vent material with scores, however it will be understood that any of the notches hereinafter disclosed may alternatively or additionally include another type of scoring which produces the weakened portion of vent material. The scores 51, 52, and 53 may be configured to easily fracture when a preset predetermined fracture pressure is reached within the battery. The pressure may be a pressure difference between the inside and outside of the battery 100 and may be generated by, for example, gas formation within the battery or by expansion of the electrolyte and/or the electrode assembly 10. In additional aspects, scores 211, 212, 213; 231, 232, 233; 241, 242, 243; 131; 141, 142, 143; and 121, 122, 123 may have a similar structure to scores 51, 52, and 53, that may be in the form of notches.

The vent structure 50 may include two lateral notches or side notches 52 and 53 and a connection notch 51 that connects the side notches 52 and 53. Each of the connection notch 51 and the side notches 52 and 53 may be formed as an elongated groove, and may be formed as a groove having a trapezoidal cross-section of the longitudinal direction, i.e. a trapezoidal longitudinal-sectional shape. However, the present disclosure is not limited thereto, and each of the connection notch 51 and the side notches 52 and 53 may have various longitudinal-sectional shapes such as a triangular shape, or an arc shape.

Furthermore, the connection notch 51 and the side notches 52 and 53 may fracture at a preset predetermined pressure. As illustrated in FIG. 5, a base recess 55 may be formed in the vent structure 50. The connection notch 51 and the side notches 52 and 53 may be formed in a surface of the base recess 55.

The connection notch 51 may include a first curved line 51a and a second curved line 51b that are formed of curves. The first curved line 51a and the second curved line 51b may be formed in an arc shape, and may protrude convexly in different directions. For example, a line that protrudes in a direction may be bowed out in the direction that the line protrudes to form a bulge of the line in the direction that the line protrudes.

The first curved line 51a may protrude convexly toward one side edge of the vent structure 50 (in a-x-axis direction), and the second curved line 51b may protrude convexly toward another side edge of the vent structure 50 (in the x-axis direction). Accordingly, the first curved line 51a and the second curved line 51b may protrude convexly in opposite directions to form a wave shape or an S-shape.

Here, an inflection point CP1 at which the first curved line 51a and the second curved line 51b meet may be formed at a center in the longitudinal direction of the connection notch 51. In addition, the first curved line 51a and the second curved line 51b may have the same curvature radius. For example, the first curved line 51a and the second curved line 51b may be formed to have a first curvature radius R11. Accordingly, the connection notch 51 may be formed in point symmetry with respect to the inflection point CP1.

The two side notches 52 and 53 may be formed to protrude convexly in opposite directions, protruding convexly outward in the longitudinal direction of the vent structure 50. The connection notch 51 is connected to the first side notch 52 and the second side notch 53. The first side notch 52 and the second side notch 53 may have the same shape and may be arranged in line symmetry, for example, as mirror images of each other.

The first side notch 52 may include a curved portion 52a that is curved in an arc shape, a first linear portion 52b that is connected to one end of the curved portion 52a and extends linearly, and a second linear portion 52c that is connected to a remaining end of the curved portion 52a and extends linearly.

The first linear portion 52b and the second linear portion 52c may extend in the longitudinal direction (y-axis direction) of the cap plate 21, and may be arranged parallel to each other. The curved portion 52a is formed in an arc having a second curvature radius R12 and is configured to partially enclose the connection notch 51.

The second side notch 53 may include a curved portion 53a that is curved in an arc shape, a first linear portion 53b that is connected to one end of the curved portion 53a and extends linearly, and a second linear portion 53c that is connected to a remaining end of the curved portion 53a and extends linearly. Furthermore, the connection notch 51 may be connected to longitudinal central portions of the first side notch 52 and the second side notch 53.

The first side notch 52 and the second side notch 53 may be spaced apart from each other by a distance, and may be formed to partially surround the connection notch 51. Here, the first side notch 52 and the second side notch 53 may surround 50% to 90% of the connection notch 51.

A first distance G11, which is a maximum distance between the connection notch 51 and a virtual reference line SL1 positioned at a center in the width direction (x-axis direction) of the vent structure 50 and extending in the longitudinal direction (y-axis direction) and along the major axis of the vent structure 50, may be 0.05 times to 0.4 times a second distance G12, which is a maximum distance from the virtual reference line SL1 to the first side notch 52.

As illustrated in FIG. 6, an inclination angle A11 of an acute angle formed by a tangent line SL2 of the connection notch 51 and the virtual reference line SL1 that meet at the inflection point CP1 may range from 5 degrees to 60 degrees. In an aspect, the inclination angle A11 of the acute angle may range from 10 degrees to 30 degrees.

The first curvature radius R11 and the second curvature radius R12 may be formed to be different from each other. The first curvature radius R11 may be greater than the second curvature radius R12. The first curvature radius R11 may be 1.1 times to 5.5 times the second curvature radius R12. Moreover, the first curvature radius R11 may be 1.8 times to 2.2 times the second curvature radius R12.

In the case where the first curvature radius R11 is greater than the second curvature radius R12, a line of the connection notch 51 may extend as a gentle curve. Hence, when the connection notch 51 is fractured, the connection notch 51 may be easily fractured along the curve.

In the case where the first curvature radius R11 is smaller than the second curvature radius R12, as illustrated in FIG. 7, in some instances there may be a concern in that vent pieces 50a and 50b, which are fractured and folded, may have a large height deviation. If the height deviation of the vent pieces 50a and 50b is too large for the surroundings, a higher portion thereof may come into contact with an upper structure, resulting in a failure to open properly, or requiring a large space to be secured above the vent pieces 50a and 50b.

In the case where the connection notch 51 extends along a curve similar to an S-shape, an area subjected to pressure may increase compared to a straight line, so that the connection notch 51 can be accurately and easily fractured at a preset fracture pressure. In addition, when fractured, the connection notch 51 can be easily and rapidly fractured along the curve. By allowing for easy and rapid fracturing along the curve, the connection notch may initiate the opening of the vent part.

The curved portions 52a and 53a of the side notches 52 and 53 may be fractured, while the first linear portions 52b and 53b and the second linear portions 52c and 53c may be folded rather than being fractured. Because the first linear portions 52b and 53b and the second linear portions 52c and 53c are present, the vent pieces 50a and 50b may be easily bent to rapidly secure a discharge space. In addition, depending on an environment where the fracture occurs, the first linear portions 52b and 53b and the second linear portions 52c and 53c may be partially or fully fractured. The side notches 52 and 53 may allow the vent part to open to its maximum extent after the opening is initiated by the connection notch. Additionally, the side notches may minimize obstruction or interference from the vent pieces 50a and 50b during gas discharge.

In some cases, the connection notch 51 may not be fractured, and the side notches 52 and 53 may be fractured first. In this case, the curved portion 52a, the first linear portions 52b and 53b, and the second linear portions 52c and 53c may all be fractured, thereby forming two openings on opposite sides, and securing sufficient space for gas discharge.

Hereinafter, a secondary battery according to a second aspect of the present disclosure will be described.

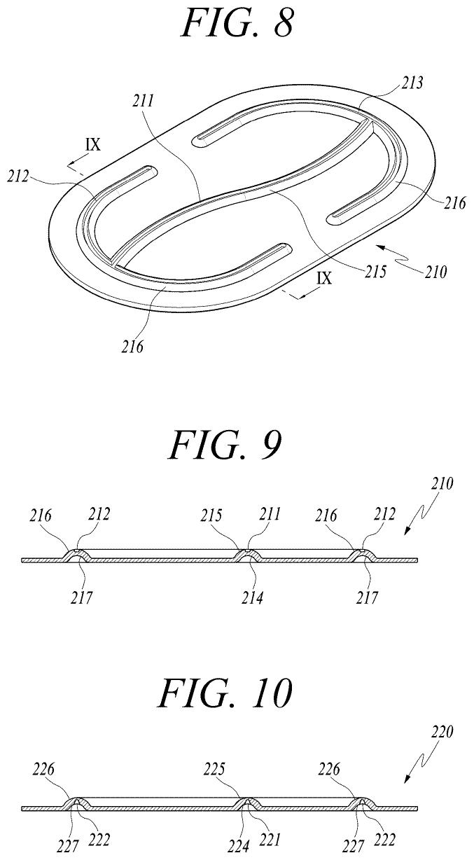

FIG. 8 is a perspective view illustrating a vent structure according to a second aspect of the present disclosure. FIG. 9 is a sectional view taken along line IX-IX of FIG. 8.

In the following description, with reference to FIGS. 8 and 9, a secondary battery according to the second aspect has the same structure as the secondary battery according to the first aspect, except for a vent structure 210; therefore, a redundant description of the same configuration will be omitted.

The vent structure 210 may include two side notches 212 and 213, and a connection notch 211 that connects the side notches 212 and 213.

The vent structure 210 may include a first elongated protrusion 215 that extends longitudinally along the connection notch 211 and protrudes convexly, and second elongated protrusions 216 that extend longitudinally along the respective side notches 212 and 213 and protrude convexly. The vent structure 210 may include the two second elongated protrusions 216. The second elongated protrusions 216 may be connected to the first elongated protrusion 215. In addition, a first elongated groove 214 may be formed in a surface opposite to the first elongated protrusion 215. A second elongated groove 217 may be formed in a surface opposite to each of the second elongated protrusions 216.

The first elongated protrusion 215 and second elongated protrusions 216 that protrude convexly may protrude convexly from a surface of the vent structure 210. The first elongated protrusion 215 and second elongated protrusions 216 may, for example, be formed as ridges protruding from the surface of the vent structure 210. The first elongated protrusion 215 and second elongated protrusions 216 may each have a constant height of an uppermost portion along the lengths thereof. The first elongated protrusion 215 and second elongated protrusion 216 may have heights of the uppermost portions that vary along the lengths thereof. The height, or maximum height, or minimum height of the first elongated protrusion 215 and the second elongated protrusions 216 may be the same or different.

The connection notch 211 may be formed in the first elongated protrusion 215, and may be positioned at an uppermost portion of the first elongated protrusion 215. The connection notch 211 may also be positioned along the first elongated protrusion 215 at a height that is not the highest part of the first elongated protrusion 215. A portion of the connection notch 211 may be positioned at an uppermost portion of the elongated protrusion 215 and a portion of the connection notch 211 may be positioned along the first elongated protrusion 215 at a height that is not the highest part of the first elongated protrusion 215. In addition or in the alternative, the side notches 212 and 213 may be formed in the second elongated protrusions 216, and may be positioned at uppermost portions of the second elongated protrusions 216. The side notches 212 and 213 may also be positioned along the second elongated protrusion 216 at a height that is not the highest part of the second elongated protrusion 216. A portion of either or both of the side notches 212 and 213 may be positioned at an uppermost portion of the second elongated protrusion 216 and a portion of either or both of the side notches 212 and 213 may be positioned along the second elongated protrusion 216 at a height that is not the highest part of the second elongated protrusion 216. A cross-section of the longitudinal direction, i.e., a longitudinal-sections of the first elongated protrusion 215 and the second elongated protrusions 216 may each be formed in an arc shape or a triangular shape. Although other shapes may be used.

In the case where the first elongated protrusion 215 and the second elongated protrusions 216 are formed as in the second aspect, the connection notch 211 and the side notches 212 and 213 may be easily fractured when needed.

Hereinafter, a secondary battery according to a third aspect of the present disclosure will be described.

FIG. 10 is a sectional view illustrating a vent structure according to the third aspect of the present disclosure.

In the following description, with reference to FIG. 10, the secondary battery according to the third aspect has the same structure as the secondary battery according to the first aspect, except for a vent structure 220; therefore, a redundant description of the same configuration will be omitted. The first elongated protrusion 225 and second elongated protrusions 226 may have shapes similar to those described in the second aspect.

The vent structure 220 may include two side notches 222 and a connection notch 221 that connects the side notches 222. In addition, the vent structure 220 may include a first elongated protrusion 225 that extends in a longitudinal direction of the connection notch 221 and protrudes convexly, and second elongated protrusions 226 that extend in longitudinal directions of the respective side notches 222 and protrude convexly.

The vent structure 220 may include the two second elongated protrusions 226. The second elongated protrusions 226 may be connected to the first elongated protrusion 225. A first elongated groove 224 may be formed in a surface opposite to the first elongated protrusion 225. A second elongated groove 227 may be formed in a surface opposite to each of the second elongated protrusions 226.

The first elongated groove 224 and the second elongated groove 227 may be formed in a surface of the vent structure 220 that faces an inner side of the casing. The first elongated groove 224 may extend in the longitudinal direction of the connection notch 221, and may have a recessed structure in a concave shape. The second elongated groove 227 may extend in the longitudinal direction of the side notch 222, and may have a recessed structure in a concave shape.

The connection notch 221 may be positioned in a bottom of the first elongated groove 224, and the side notches 222 may be positioned in bottoms of the respective second elongated grooves 227. Accordingly, the connection notch 221 and the side notches 222 are also formed in the surface of the vent structure 220 that faces the inner side of the casing.

Hereinafter, a secondary battery according to a fourth aspect of the present disclosure will be described.

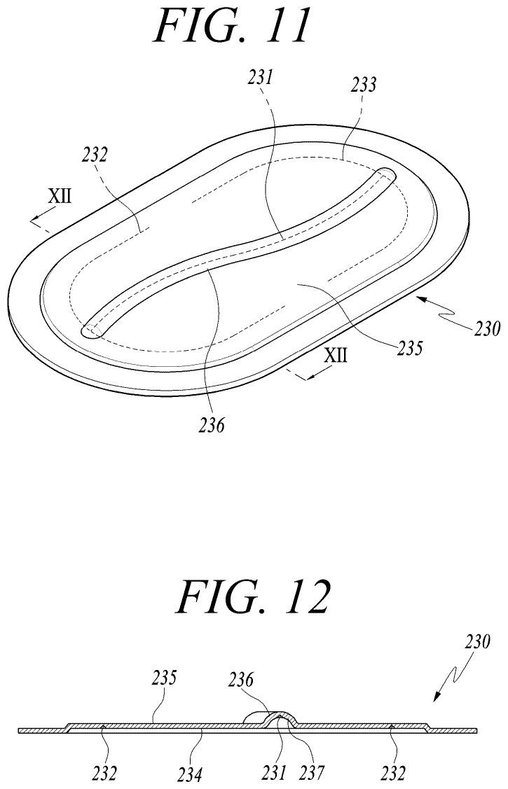

FIG. 11 is a perspective view illustrating a vent structure according to the fourth aspect of the present disclosure. FIG. 12 is a sectional view taken along line XII-XII of FIG. 11.

In the following description, with reference to FIGS. 11 and 12, the secondary battery according to the fourth aspect has the same structure as the secondary battery according to the first aspect, except for a vent structure; therefore, a redundant description of the same configuration will be omitted.

The vent structure 230 may include two side notches 232 and 233, and a connection notch 231 that connects the side notches 232 and 233. Furthermore, the vent structure 230 may include a first recess 234 that encloses the side notches 232 and 233 and the connection notch 231, and a second recess 237 that extends in a longitudinal direction of the connection notch 231.

The first recess 234 may be positioned in a lower surface of the vent structure 230. The side notches 232 and 233 may be positioned in the first recess 234. The first recess 234 may have an oval-shaped, or “track”-shaped, cross-section in which two semicircles are connected by two straight lines.

The second recess 237 may be formed in a recessed manner from a bottom of the first recess 234, and the connection notch 231 may be positioned in the second recess 237. The second recess 237 may extend in a longitudinal direction of the connection notch 231 and may be formed to enclose the connection notch 231.

A first protrusion 235 may be formed on a surface opposite to the first recess 234 and protrude from the vent structure. A second protrusion 236 may be formed on a surface opposite to the second recess 237 and protrude from the first protrusion 235. The second protrusion 236 may be located on the first protrusion 235.

In the case where the second recess 237 is formed in the bottom of the first recess 234 and the connection notch 231 is positioned in the second recess 237 as in the fourth aspect, pressure may be concentrated on the connection notch 231, and the connection notch 231 may be easily fractured when needed.

Hereinafter, a secondary battery according to a fifth aspect of the present disclosure will be described.

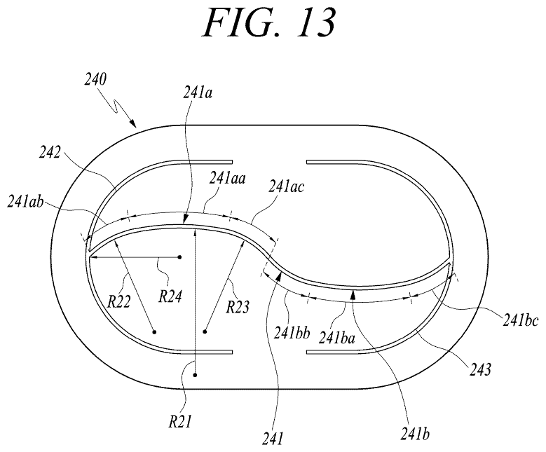

FIG. 13 is a plan view illustrating a vent structure according to the fifth aspect of the present disclosure.

In the following description, with reference to FIG. 13, the secondary battery according to the fifth aspect has the same structure as the secondary battery according to the first aspect, except for a vent structure 240; therefore, a redundant description of the same configuration will be omitted.

The vent structure 240 may include two side notches 242 and 243, and a connection notch 241 that connects the side notches 242 and 243. The connection notch 241 may include a first curved line 241a and a second curved line 241b formed of curves. The first curved line 241a and the second curved line 241b may be formed in an arc shape and may protrude convexly in different directions. For example, a line that protrudes in a direction may be bowed out in the direction that the line protrudes to form a bulge of the line in the direction that the line protrudes.

The first curved line 241a may protrude convexly toward one side edge of the vent structure 240, and the second curved line 241b may protrude convexly toward another side edge of the vent structure 240. The first curved line 241a and the second curved line 241b may have the same shape but may protrude convexly in opposite directions.

The first curved line 241a may be formed of a curve having a plurality of curvature radii. The first curved line 241a may include a first portion 241aa having a first curvature radius R21, a second portion 241ab connected to one longitudinal end of the first portion 241aa and having a second curvature radius R22, and a third portion 241ac connected to a remaining longitudinal end of the first portion 241aa and having a third curvature radius R23. The first curvature radius R21 may be greater than the second curvature radius R22, and the first curvature radius R21 may be 1.1 times to 2.5 times the second curvature radius R22. The second curvature radius R22 and the third curvature radius R23 may be formed to be the same.

The second curved line 241b may be formed of a curve having a plurality of curvature radii. The second curved line 241b may include a first portion 241ba, a second portion 241bb connected to one longitudinal end of the first portion 241ba, and a third portion 241bc connected to a remaining longitudinal end of the first portion 241ba.

A curvature radius of the first portion 241ba may be greater than a curvature radius of each of the second portion 241bb and the third portion 241bc. The curvature radii of the second portion 241bb and the third portion 241bc may be formed to be the same.

The two side notches 242 and 243 may protrude convexly in opposite directions, and may each include a curved portion extending in an arc shape. The two side notches 242 and 243 may be spaced apart from each other by a distance, and may be formed to partially enclose the connection notch 241. The curved portions of the side notches 242 and 243 may have a fourth curvature radius R24.

The fourth curvature radius R24 may be smaller than each of the first curvature radius R21 and the second curvature radius R22, and the fourth curvature radius R24 may be 0.3 times to 0.7 times the second curvature radius R22.

In the case where the first curved line 241a and the second curved line 241b have multiple curvature radii as in the fifth aspect, the degree of design freedom of the connection notch 241 may be further increased, and the connection notch 241 may be easily fractured at a preset pressure with improved accuracy. As the length of the connection notch increases, as compared with a single radius of curvature, the area under pressure also increases due to increased notch length, which allows for venting to occur more easily.

Hereinafter, a secondary battery according to a sixth aspect of the present disclosure will be described.

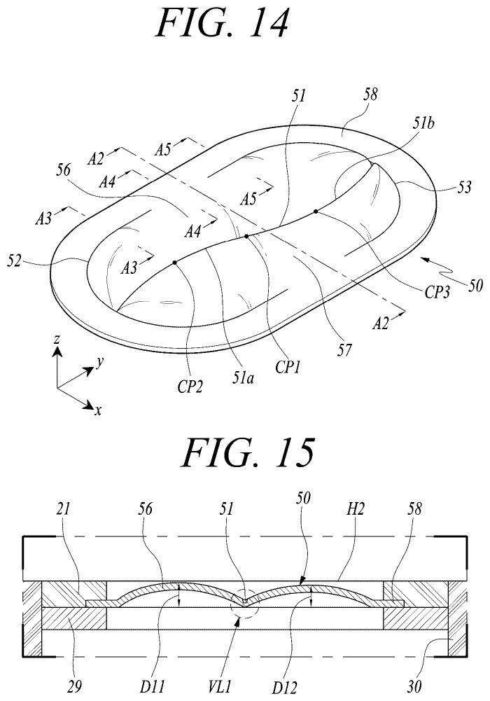

FIG. 14 is a perspective view illustrating the vent structure according to the sixth aspect of the present disclosure. FIG. 15 is a sectional view taken along line A2-A2 of FIG. 14.

In the following description, with reference to FIGS. 14 and 15, the secondary battery according to the sixth aspect has the same structure as the secondary battery according to the first aspect described above, except for a vent structure; therefore, a redundant description of the same configuration will be omitted.

Referring to FIGS. 14 and 15, the vent structure 50 may include a first convex portion 56 and a second convex portion 57 that are formed between the connection notch 51 and the side notches 52 and 53. The first convex portion 56 may be located between one side edge of the connection notch 51 and the side notches 52 and 53. The second convex portion 57 may be located between a remaining side edge of the connection notch 51 and the side notches 52 and 53.

The first convex portion 56 and the second convex portion 57 may be spaced apart from each other with the connection notch 51 interposed therebetween and may be arranged adjacent to each other. For example, the first convex portion 56 may be disposed on a left side of the connection notch 51, and the second convex portion 57 may be disposed on a right side of the connection notch 51. The first convex portion and second convex portion may be provided as a pair of convex portions. However, the vent structure is not limited to two convex portions and may include more convex portions spaced apart by additional portions of the connection notch. For instance, three convex portions may be formed by a connection notch having three curved lines, and four convex portions may be formed by a connection notch having four curved lines.

A support plate 58, which is formed of a flat plate and is inserted between the cap plate 21 and the upper insulator 29, may be formed outside the first convex portion 56 and the second convex portion 57.

The first convex portion 56 and the second convex portion 57 may extend from a region where the connection notch 51 and the first side notch 52 are connected to a region where the connection notch 51 and the second side notch 53 are connected. A concave portion may be formed on an opposite surface of each of the first convex portion 56 and the second convex portion 57.

A height of the first convex portion 56 may be formed to be different from a height of the second convex portion 57. The height of the first convex portion 56 may be greater than the height of the second convex portion 57.

Accordingly, a first distance D11 between an upper end of the first convex portion 56 and an inner end of the vent structure 50 may be greater than a second distance D12 between an upper end of the second convex portion 57 and the inner end of the vent structure 50. The first distance D11 may range from 1.02 times to 2.5 times the second distance D12. When the heights of the first convex portion 56 and the second convex portion 57 differ from each other, the notches may be more easily fractured due to an imbalance of force.

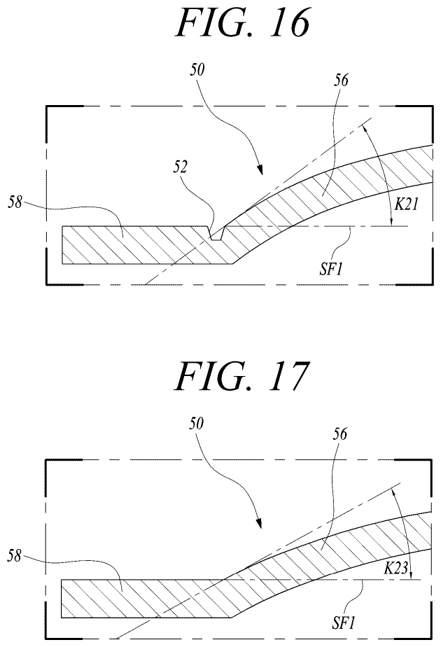

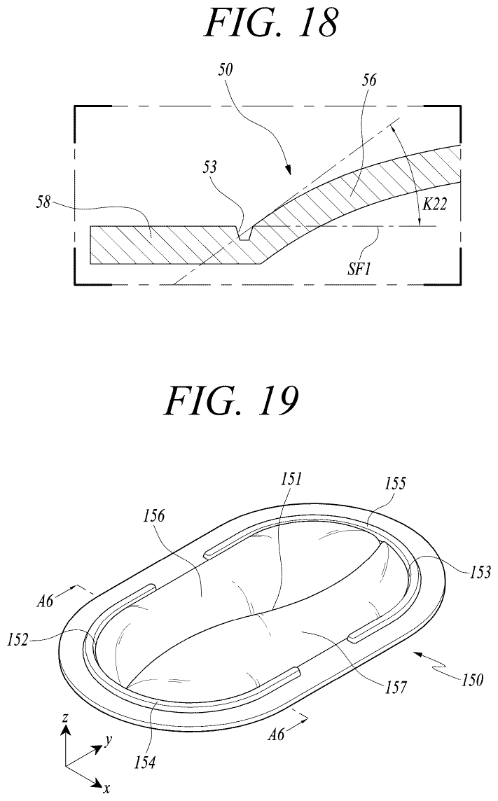

FIG. 16 is a sectional view taken along line A3-A3 of FIG. 14. FIG. 17 is a sectional view taken along line A4-A4 of FIG. 14. FIG. 18 is a sectional view taken along line A5-A5 of FIG. 14.

Referring to FIG. 14 and FIGS. 16 to 18, the connection notch 51 may include an inflection point CP1 at which the first curved line 51a and the second curved line 51b meet, a first reference point CP2 at which the first curved line 51a forms a maximum distance from the reference line SL1 extending in a longitudinal direction of the vent structure 50 at a center in a width direction of the vent structure 50, and a second reference point CP3 at which the second curved line 51b forms a maximum distance from the reference line SL1. The connection notch is not limited to a first curved line 51a and a second curved line 51b. In some aspects, additional curved lines can be provided which meet at a middle point instead of an inflection point. In one example, three curved lines can be arranged to meet at the middle point and the ends of the three curved lines may be spaced 120 degrees apart from each other, although other angles may be used. In another example, four curved lines can be arranged to meet at the middle point and the ends of the four curved lines may be spaced 90 degrees apart, although other angles may be used. In another aspect, the lengths of the curved lines forming the connection notch may be the same or one or more may have a different length.

In addition, a first inclination angle K21 formed between a tangent line at an outer edge of the first convex portion 56 of the vent structure 50 in the width direction at the first reference point CP2 and a virtual reference plane SF1 parallel to the cap plate 21, and a second inclination angle K22 formed between a tangent line at an outer edge of the first convex portion 56 in the width direction at the second reference point CP3 and the reference plane SF1, may each be greater than a third inclination angle K23 formed between a tangent line at an outer edge of the first convex portion 56 in the width direction at the inflection point CP1 and the reference plane SF1.

Here, the phrase “outer edge of the first convex portion 56 in the width direction at the first reference point CP2, the second reference point CP3, or the inflection point CP1” may refer to an outer edge of the first convex portion 56 that intersects with a line extending in the width direction of the first convex portion 56 at the first reference point CP2, the second reference point CP3, or the inflection point CP1.

Furthermore, the first inclination angle K21 and the second inclination angle K22 may each range from 1.2 times to 2.5 times the third inclination angle K23.

For example, the first inclination angle K21 and the second inclination angle K22 may each range from 6 degrees to 25 degrees, and the third inclination angle K23 may range from 5 degrees to 15 degrees.

In the case where the first inclination angle K21 and the second inclination angle K22 are each greater than the third inclination angle K23, upon swelling of a central portion of the vent structure 50, uniform deformation of the central portion and side portions of the vent structure 50 may be induced, thereby facilitating fracture of the notches. In particular, when the first inclination angle K21 and the second inclination angle K22 each range from 1.2 times to 2.5 times the third inclination angle K23, an opening pressure of the vent structure 50 may be more precisely controlled.

According to the present aspect, the first convex portion 56 and the second convex portion 57 are formed, and since the heights of the first convex portion 56 and the second convex portion 57 are different from each other, the notches may be easily and reliably fractured at a preset pressure.

In the case where the connection notch 51 extends along a curve similar to an S-shape, an area subjected to pressure may increase compared to that of a straight line, so that the connection notch 51 can be accurately and easily fractured at a preset fracture pressure. In addition, when fractured, the connection notch 51 can be easily and rapidly fractured along the curve.

The curved portions 52a and 53a of the side notches 52 and 53 may be fractured, while the first linear portions 52b and 53b and the second linear portions 52c and 53c may be folded rather than being fractured. Because the first linear portions 52b and 53b and the second linear portions 52c and 53c are present, the vent pieces may be easily bent to rapidly secure a discharge space. In addition, depending on an environment where the fracture occurs, the first linear portions 52b and 53b and the second linear portions 52c and 53c may be partially or fully fractured.

In some cases, the connection notch 51 may not be fractured, and the side notches 52 and 53 may be fractured first. In this case, the curved portion 52a, the first linear portions 52b and 53b, and the second linear portions 52c and 53c may all be fractured, thereby forming two openings on opposite sides, and securing sufficient space for gas discharge.

Hereinafter, a secondary battery according to a seventh aspect of the present disclosure will be described.

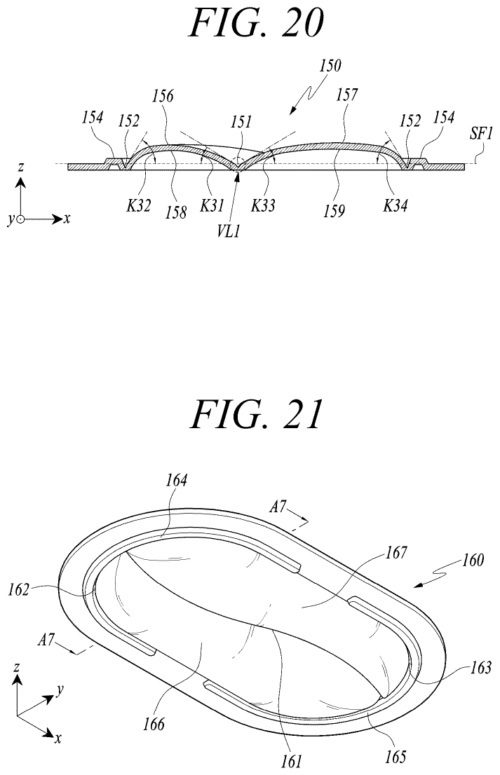

FIG. 19 is a perspective view illustrating a vent structure according to the seventh aspect of the present disclosure. FIG. 20 is a sectional view taken along line A6-A6 of FIG. 19.

In the following description, with reference to FIGS. 19 and 20, the secondary battery according to the seventh aspect has the same structure as the secondary battery according to the sixth aspect described above, except for a vent structure 150; therefore, a redundant description of the same configuration will be omitted.

The vent structure 150 may include two side notches 152 and 153, and a connection notch 151 that connects the side notches 152 and 153. The side notches 152 and 153 and the connection notch 151 may be formed on an outer surface of the vent structure 150 that faces away from an outer side of the casing.

The connection notch 151 and the side notches 152 and 153 according to the seventh aspect may have the same structure as the connection notch and the side notches of the sixth aspect described above.

In addition, the vent structure 150 may further include a first support rib 154, which is located outside the first side notch 152 and encloses the first side notch 152, and a second support rib 155, which is located outside the second side notch 153 and encloses the second side notch 153.

The first support rib 154 may be disposed farther from a center of the vent structure 150 than the first side notch 152, and may be connected to an upper end of the first side notch 152. However, the present disclosure is not limited thereto, and the first support rib 154 may be spaced apart from the first side notch 152.

The first support rib 154 may serve to prevent deformation of the vent structure 150 and to support the vent structure 150 so that the first side notch 152 may be easily torn when the first side notch 152 fractures.

Furthermore, the second support rib 155 may be disposed farther from the center of the vent structure 150 than the second side notch 153, and may be connected to an upper end of the second side notch 153. However, the present disclosure is not limited thereto. The second support rib 155 may serve to prevent deformation of the vent structure 150 and to support the vent structure 150 so that the second side notch 153 may be easily torn when the second side notch 153 fractures.

Furthermore, the vent structure 150 may include a first convex portion 156 and a second convex portion 157 that are formed between the connection notch 151 and the side notches 152 and 153. The first convex portion 156 may be located between one side edge of the connection notch 151 and the side notches 152 and 153. The second convex portion 157 may be located between a remaining side edge of the connection notch 151 and the side notches 152 and 153. For example, the first convex portion 156 may be disposed on a left side of the connection notch 151, and the second convex portion 157 may be disposed on a right side of the connection notch 151.

The first convex portion 156 and the second convex portion 157 may extend from a region where the connection notch 151 and the first side notch 152 are connected to a region where the connection notch 151 and the second side notch 153 are connected. A first concave portion 158 may be formed on an opposite surface of the first convex portion 156. A second concave portion 159 may be formed on an opposite surface of the second convex portion 157. The first convex portion 156 and the second convex 157 portion may protrude convexly outward away from the interior of the casing.

The connection notch 151 may be located at a valley portion VL1 formed between the first convex portion 156 and the second convex portion 157. The first side notch 152 may be located between the first convex portion 156 and the first support rib 154, and between the second convex portion 157 and the first support rib 154. The second side notch 153 may be located between the first convex portion 156 and the second support rib 155, and between the second convex portion 157 and the second support rib 155.

A first tangential angle K31, which is formed between a tangent line at an edge of the first convex portion 156 adjacent to the connection notch 151 and the virtual reference plane SF1 parallel to the cap plate 21, may be smaller than a second tangential angle K32, which is formed between a tangent line at an edge of the first convex portion 156 adjacent to the first side notch 152 or the second side notch 153 and the reference plane SF1.

The first tangential angle K31 may range from 1 degree to 20 degrees, and the second tangential angle K32 may range from 2 degrees to 30 degrees. In addition, the first tangential angle K31 may range from 2 degrees to 15 degrees, and the second tangential angle K32 may range from 2 degrees to 25 degrees.

The second tangential angle K32 may range from 1.1 times to 3.5 times the first tangential angle K31. Furthermore, a difference between the first tangential angle K31 and the second tangential angle K32 may range from 1 degree to 10 degrees.

A third tangential angle K33, which is formed between a tangent line at an edge of the second convex portion 157 adjacent to the connection notch 151 and the virtual reference plane SF1 parallel to the cap plate 21, may be smaller than a fourth tangential angle K34, which is formed between a tangent line at an edge of the second convex portion 157 adjacent to the first side notch 152 or the second side notch 153 and the reference plane SF1.

The fourth tangential angle K34 may range from 1.1 times to 3.5 times the third tangential angle K33. A difference between the third tangential angle K33 and the fourth tangential angle K34 may range from 1 degree to 10 degrees.

The third tangential angle K33 may range from 1 degree to 20 degrees, and the fourth tangential angle K34 may range from 2 degrees to 30 degrees. In addition, the third tangential angle K33 may range from 2 degrees to 15 degrees, and the fourth tangential angle K34 may range from 2 degrees to 25 degrees.

As described above, according to the seventh aspect, the first support rib 154 and the second support rib 155 are formed, thereby preventing deformation of the vent structure 150 and enabling the side notches 152 and 153 to be easily torn.

Furthermore, because a tangential angle at a portion of each of the first convex portion 156 and the second convex portion 157 that is connected to the connection notch 151 is smaller than a tangential angle at a portion of each of the first convex portion 156 and the second convex portion 157 that is connected to the side notches 152 and 153, the connection notch 151 that is positioned in a central portion may not only be easily deformed upward by pressure, but the connection notch 151 and the side notches 152 and 153 may also be easily fractured.

Hereinafter, a secondary battery according to a eighth aspect of the present disclosure will be described.

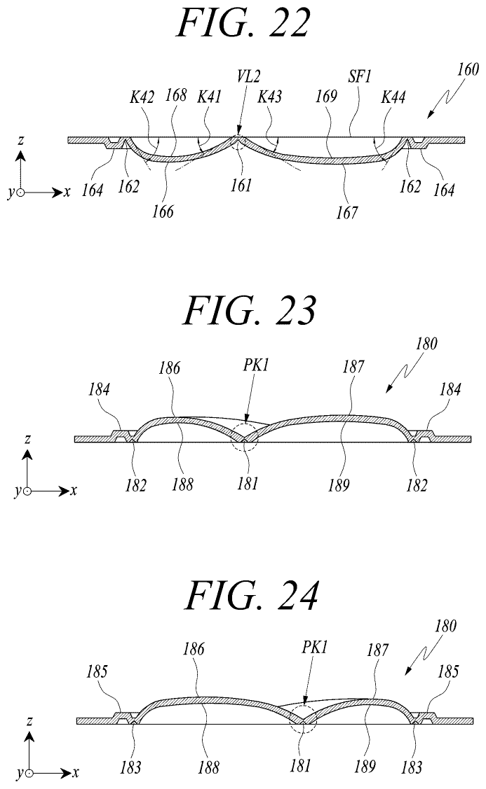

FIG. 21 is a bottom perspective view illustrating a vent structure according to a eighth aspect of the present disclosure. FIG. 22 is a sectional view taken along line A7-A7 of FIG. 21.

Referring to FIGS. 21 and 22, the secondary battery according to the eighth aspect has the same structure as the secondary battery according to the sixth aspect described above, except for a vent structure 160; therefore, a redundant description of the same configuration will be omitted.

The vent structure 160 may include two side notches 162 and 163, and a connection notch 161 that connects the side notches 162 and 163. The side notches 162 and 163 and the connection notch 161 may be formed on an inner surface of the vent structure 160 that faces inside the casing. The connection notch 161 and the side notches 162 and 163 according to the eighth aspect may have the same structure as the connection notch and the side notches of the sixth aspect described above.

The vent structure 160 may further include a first support rib 164, which is located outside the first side notch 162 and encloses the first side notch 162, and a second support rib 165, which is located outside the second side notch 163 and encloses the second side notch 163. The first support rib 164 and the second support rib 165 may protrude toward the inner side of the casing.

The first support rib 164 may be disposed farther from a center of the vent structure 160 than the first side notch 162, and the second support rib 165 may be disposed farther from the center of the vent structure 160 than the second side notch 163.

Furthermore, the vent structure 160 may include a first convex portion 166 and a second convex portion 167 that are formed between the connection notch 161 and the side notches 162 and 163. The first convex portion 166 and the second convex portion 167 may protrude toward the inner side of the casing. The first convex portion 166 and the second convex 167 portion may protrude convexly inwardly and face inside the casing.

The first convex portion 166 and the second convex portion 167 may be positioned with the connection notch 161 interposed therebetween. A first concave portion 168 may be formed on an opposite surface of the first convex portion 166. A second concave portion 169 may be formed on an opposite surface of the second convex portion 167.

The connection notch 161 may be located at a valley portion VL2 formed between the first convex portion 166 and the second convex portion 167. The first side notch 162 may be located between the first convex portion 166 and the first support rib 164, and between the second convex portion 167 and the first support rib 164. The second side notch 163 may be located between the first convex portion 166 and the second support rib 165, and between the second convex portion 167 and the second support rib 165.

A first tangential angle K41, which is formed between a tangent line at an edge of the first concave portion 168 adjacent to the connection notch 161 and the virtual reference plane SF1 parallel to the cap plate 21, may be smaller than a second tangential angle K42, which is formed between a tangent line at an edge of the first concave portion 168 adjacent to the first side notch 162 and the reference plane SF1.

The first tangential angle K41 may range from 1 degree to 20 degrees, and the second tangential angle K42 may range from 2 degrees to 30 degrees. In addition, the first tangential angle K41 may range from 2 degrees to 15 degrees, and the second tangential angle K42 may range from 2 degrees to 25 degrees. A difference between the first tangential angle K41 and the second tangential angle K42 may range from 1 degree to 10 degrees.

A third tangential angle K43, which is formed between a tangent line at an edge of the second concave portion 169 adjacent to the connection notch 161 and the virtual reference plane SF1 parallel to the cap plate 21, may be smaller than a fourth tangential angle K44, which is formed between a tangent line at an edge of the second concave portion 169 adjacent to the first side notch 162 and the reference plane SF1.

The third tangential angle K43 may range from 1 degree to 20 degrees, and the fourth tangential angle K44 may range from 2 degrees to 30 degrees. In addition, the third tangential angle K43 may range from 2 degrees to 15 degrees, and the fourth tangential angle K44 may range from 2 degrees to 25 degrees. A difference between the third tangential angle K43 and the fourth tangential angle K44 may range from 1 degree to 10 degrees.

As described above, according to the third aspect, the side notches 162 and 163 and the connection notch 161 are formed on the inner surface of the vent structure 160 that faces the inner side of the casing, and the first convex portion 166 and the second convex portion 167 protrude toward the inner side of the casing. Therefore, the side notches 162 and 163, the connection notch 161, the first convex portion 166, and the second convex portion 167 may be prevented from being damaged by external impact or pressure during a transportation process or the like.

Furthermore, a tangential angle at a portion of each of the first concave portion 168 and the second concave portion 169 that is connected to the connection notch 161 is smaller than a tangential angle at a portion of each of the first concave portion 168 and the second concave portion 169 that is connected to the side notches 162 and 163. Accordingly, the connection notch 161 and the side notches 162 and 163 may be easily fractured.

Hereinafter, a secondary battery according to a ninth aspect of the present disclosure will be described.

FIG. 23 is a sectional view illustrating a portion of a vent structure in which a connection notch and a first side notch are located, according to the ninth aspect of the present disclosure. FIG. 24 is a sectional view illustrating a portion of the vent structure in which the connection notch and a second side notch are located, according to the ninth aspect of the present disclosure.

In the following description, with reference to FIGS. 23 and 24, the secondary battery according to the ninth aspect has the same structure as the secondary battery according to the sixth aspect described above, except for a vent structure 180; therefore, a redundant description of the same configuration will be omitted.

The vent structure 180 may include two side notches 182 and 183, and a connection notch 181 that connects the side notches 182 and 183. The side notches 182 and 183 and the connection notch 181 may be formed on an inner surface of the vent structure 180 that faces the inner side of the casing. The connection notch 181 and the side notches 182 and 183 according to the ninth aspect may have the same structure as the connection notch and the side notches of the sixth aspect described above.

In addition, the vent structure 180 may further include a first support rib 184, which is located outside the first side notch 182 and encloses the first side notch 182, and a second support rib 185, which is located outside the second side notch 183 and encloses the second side notch 183. The first support rib 184 and the second support rib 185 may protrude in a direction facing the outer side of the casing.

The first support rib 184 may be disposed farther from a center of the vent structure 180 than the first side notch 182. The second support rib 185 may be disposed farther from the center of the vent structure 180 than the second side notch 183.

Furthermore, the vent structure 180 may include a first convex portion 186 and a second convex portion 187 that are formed between the connection notch 181 and the side notches 182 and 183. The first convex portion 186 and the second convex portion 187 are formed on an outer surface of the vent structure and may protrude outward away from an outer side of the casing. A first concave portion 188 may be formed on an opposite inner surface of the first convex portion 186, and a second concave portion 189 may be formed on an opposite inner surface of the second convex portion 187 and facing inside the casing. The side notches 182 and 183 and the connection notch 181 may be formed on an opposite inner surface of the vent structure and facing inside the casing.

The connection notch 181 may be located at a peak portion PK1 formed between the first concave portion 188 and the second concave portion 189. The first side notch 182 may be located between the first concave portion 188 and the first support rib 184, and between the second concave portion 189 and the first support rib 184. The second side notch 183 may be located between the first concave portion 188 and the second support rib 185, and between the second concave portion 189 and the second support rib 185.

Hereinafter, a secondary battery according to a tenth aspect of the present disclosure will be described.

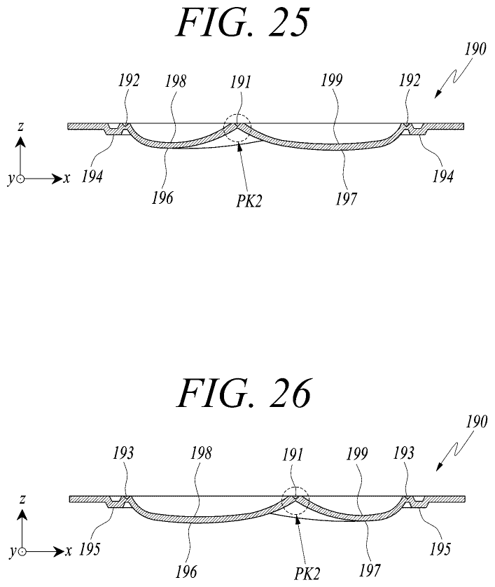

FIG. 25 is a sectional view illustrating a portion of a vent structure in which a connection notch and a first side notch are located, according to the tenth aspect of the present disclosure. FIG. 26 is a sectional view illustrating a portion of the vent structure in which the connection notch and a second side notch are located, according to the tenth aspect of the present disclosure.

In the following description, with reference to FIGS. 25 and 26, the secondary battery according to the tenth aspect has the same structure as the secondary battery according to the sixth aspect described above, except for a vent structure 190; therefore, a redundant description of the same configuration will be omitted.

The vent structure 190 may include two side notches 192 and 193, and a connection notch 191 that connects the side notches 192 and 193. The side notches 192 and 193 and the connection notch 191 may be formed on an outer surface of the vent structure 190 that faces the outer side of the casing. The connection notch 191 and the side notches 192 and 193 according to the fifth aspect may have the same structure as the connection notch and the side notches of the first aspect described above.

The vent structure 190 may further include a first support rib 194 that is located outside the first side notch 192 and encloses the first side notch 192, and a second support rib 195 that is located outside the second side notch 193 and encloses the second side notch 193. The first support rib 194 and the second support rib 195 may protrude toward the inner side of the casing.

The first support rib 194 may be located farther from a center of the vent structure 190 than the first side notch 192, and the second support rib 195 may be located farther from the center of the vent structure 190 than the second side notch 193.

The vent structure 190 may further include a first convex portion 196 and a second convex portion 197 formed between the connection notch 191 and the side notches 192 and 193. The first convex portion 196 and the second convex portion 197 may be formed on an inner surface of the vent structure and protrude toward inside the casing.

A first concave portion 198 may be formed on an opposite outer surface of the first convex portion 196, and a second concave portion 199 may be formed on an opposite outer surface of the second convex portion 197. The connection notch 191 may be located at a peak portion PK2 formed between the first concave portion 198 and the second concave portion 199. The first side notch 192 may be located between the first concave portion 198 and the first support rib 194, and between the second concave portion 199 and the first support rib 194. The second side notch 193 may be located between the first concave portion 198 and the second support rib 195, and between the second concave portion 199 and the second support rib 195. The side notches 192 and 193 and connection notch 191 may be formed on an opposite outer surface of the vent structure and facing away from the outer side of the casing.

According to an aspect of the present disclosure, a first convex portion and a second convex portion are formed in a vent structure, and a connection notch extending in a curved line is formed between the first convex portion and the second convex portion. Accordingly, stress may be concentrated on the first convex portion and the second convex portion each having a dome shape, so that the vent structure may easily open at a preset pressure. Furthermore, because the first convex portion and the second convex portion have different heights, the notch may be easily and reliably fractured at the preset pressure even in various environments in which pressure increases.

Furthermore, in the case where a connection notch includes curved lines that protrude convexly in different directions, an area subjected to pressure may increase compared to that of a straight line, so that the connection notch may be fractured accurately and easily at a predetermined fracture pressure. In addition, because the area subjected to pressure increases, overall rigidity of the vent structure may be designed to be high, and accordingly, the vent structure may be designed to open widely by a large force when the connection notch fractures.

Hereinafter, a secondary battery according to a eleventh aspect of the present disclosure will be described.

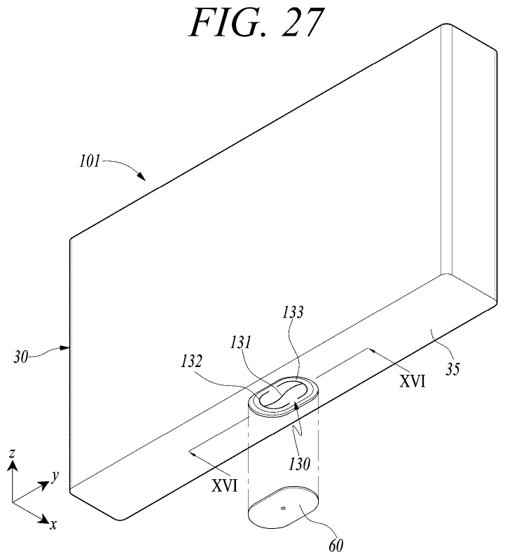

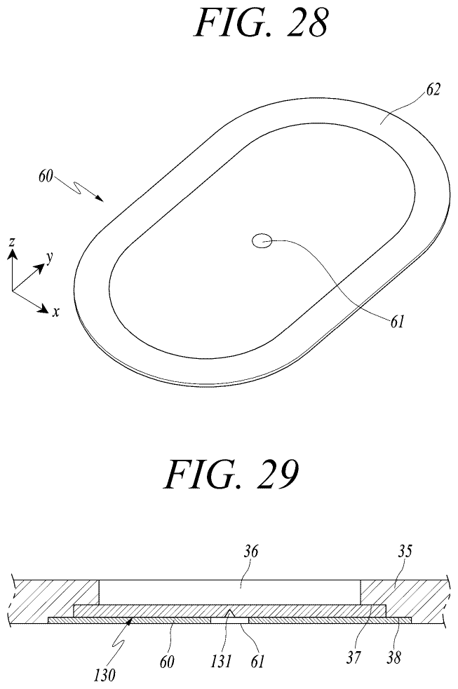

FIG. 27 is a perspective view illustrating the secondary battery according to the eleventh aspect of the present disclosure. FIG. 28 is a diagram illustrating a vent protection film according to the eleventh aspect of the present disclosure. FIG. 29 is a sectional view taken along line XVI-XVI of FIG. 27.

In the following description, with reference to FIGS. 27 to 29, the secondary battery 101 according to the eleventh aspect has the same structure as the secondary battery according to the first aspect, except for a vent structure 130; therefore, a redundant description of the same configuration will be omitted.

The secondary battery 101 may be configured as a prismatic battery having a casing 30 with a substantially rectangular pillar shape. The vent structure 130 may be fixed to a bottom 35 of the casing 30. The bottom 35 of the casing 30 may be integrally formed with the casing 30, or may be fixed to the casing 30 by welding or the like.

An exhaust hole 36 for discharging gas may be formed in the bottom 35 of the casing 30. A first stepped portion 37, into which the vent structure 130 is inserted, may be formed around a lower end of the exhaust hole 36. A second stepped portion 38, into which a vent protection film 60 is inserted, may be formed around a lower end of the first stepped portion 37.

The vent structure 130 may be formed in a plate shape, and may be fixed to the casing 30 by welding or any other method of securely fixing the vent structure 130 to the casing 30. The vent structure 130 may include two side notches 132 and 133, and a connection notch 131 that connects the side notches 132 and 133. The connection notch 131 and the side notches 132 and 133 have the same structures as those described in the first aspect; therefore, a redundant description thereof will be omitted.

The vent protection film 60 may be provided under the vent structure 50. The vent protection film 60 may be formed of a film having flexibility. A connection hole 61 for pressure release may be formed in the vent protection film 60. Furthermore, an attachment region 62 for attachment of the vent protection film 60 may be formed on a perimeter of the vent protection film 60. The attachment region 62 may adhere or fuse to the vent structure 50 or the cap plate 21.

As described above, according to the sixth aspect, the vent structure 130 is provided in the bottom 35 of the casing 30, so that an electrolyte may also be discharged together when the vent structure 130 opens.

Hereinafter, a secondary battery according to a twelfth aspect of the present disclosure will be described.

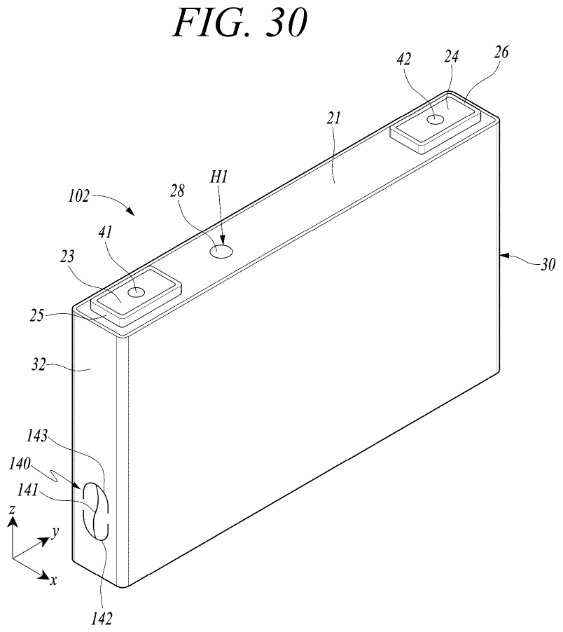

FIG. 30 is a perspective view illustrating the secondary battery according to the twelfth aspect of the present disclosure.

In the following description, with reference to FIG. 30, the secondary battery 102 according to the twelfth aspect has the same structure as the secondary battery according to the first aspect, except for a vent structure 140; therefore, a redundant description of the same configuration will be omitted.

The secondary battery 102 may be configured as a prismatic battery having a casing 30 with a substantially rectangular pillar shape. The vent structure 140 may be provided in a side surface 32 of the casing 30. The vent structure 140 may be formed in a groove shape in any one of four side surfaces 32 of the casing 30. For example, the vent structure 140 integrated with the casing 30 may be formed in the side surface 32 of the casing 30 by directly forming a groove in an outer surface of the casing 30.

The vent structure 140 may include two side notches 142 and 143, and a connection notch 141 that connects the side notches 142 and 143. Since the connection notch 141 and the side notches 142 and 143 have the same structure as the connection notch and the side notches according to the first aspect described above, a redundant description thereof will be omitted.

As described above, according to the present aspect, the vent structure 140 is formed on the side surface 32 of the casing 30, so that an electrolyte can also be discharged together when the vent structure 140 opens.

Hereinafter, a secondary battery according to an thirteenth aspect of the present disclosure will be described.

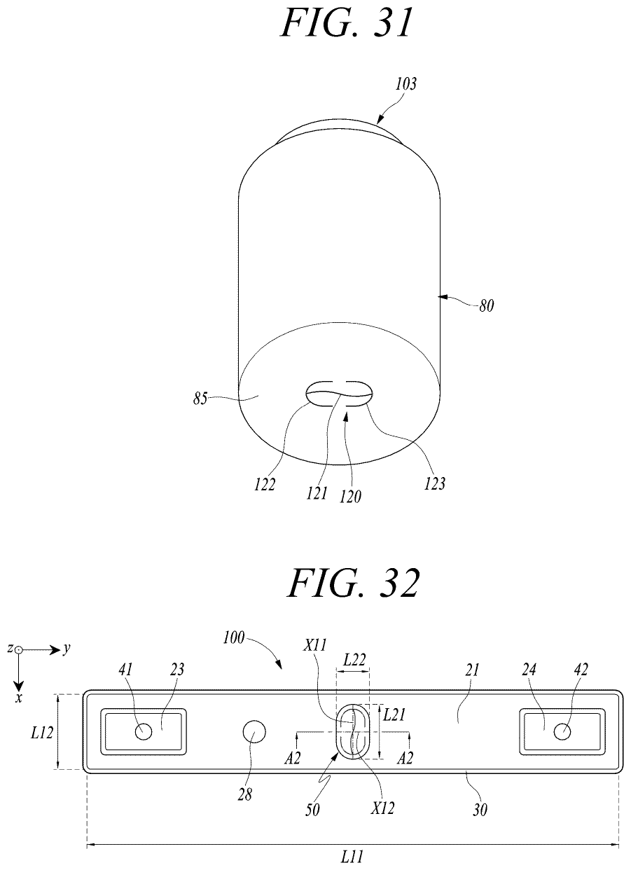

FIG. 31 is a perspective view illustrating the secondary battery according to the thirteenth aspect of the present disclosure.

Referring to FIG. 31, a secondary battery 103 according to the thirteenth aspect may be configured as a cylindrical battery having a casing 80 with a substantially cylindrical shape. A vent structure 120 may be formed in a bottom 85 of the casing 80. The bottom 85 of the casing 80 may be integrally formed with the casing 80, or may be fixed to the casing 80 by welding or the like.

The secondary battery 103 according to the thirteenth aspect may be implemented as a cylindrical battery having any of various well-known structures and is not limited to a specific cylindrical battery structure.

The vent structure 120 may be formed in the bottom 85 of the casing 80, and may be integrally formed with the casing 80 by directly forming a groove in the bottom 85 of the casing 80. However, the present disclosure is not limited thereto, and the vent structure 120 may be formed in a plate shape and be fixed to the bottom 85 of the casing 80 by welding or any other method of securely fixing the vent structure 120 to the casing 80.

The vent structure 120 may include two side notches 122 and 123, and a connection notch 121 that connects the side notches 122 and 123. Since the connection notch 121 and the side notches 122 and 123 have the same structures as the connection notch and the side notches described in the first aspect, a redundant description thereof will be omitted.

Hereinafter, a secondary battery according to a fourteenth aspect of the present disclosure will be described.

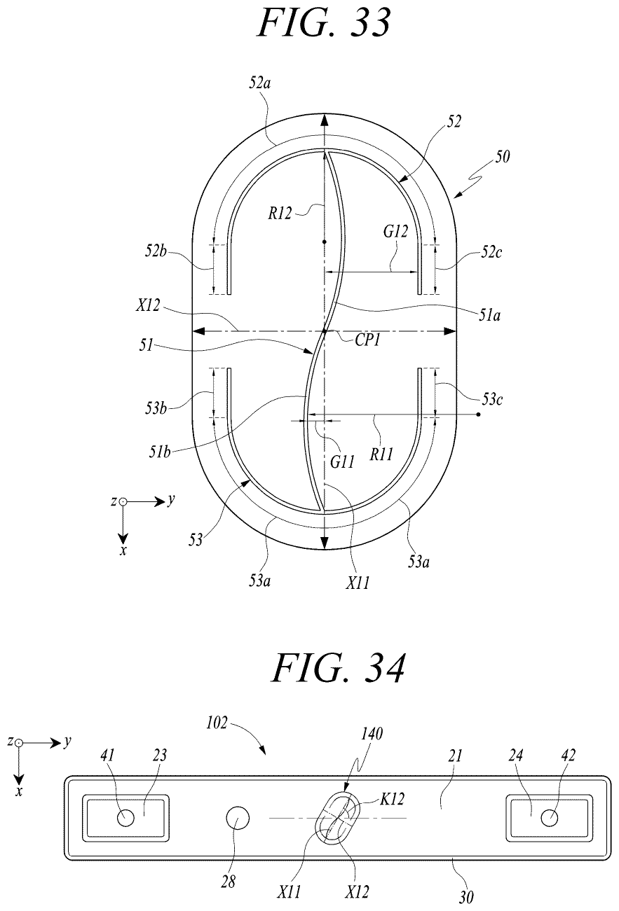

FIG. 32 is a top plan view illustrating the secondary battery according to the fourteenth aspect of the present disclosure, and FIG. 33 is a plan view illustrating vent structure of FIG. 32.

In the following description, with reference to FIG. 32 and FIG. 33, the secondary battery 104 according to the fourteenth aspect has the same structure as the secondary battery according to the first aspect, except for orientation of a vent structure 50; therefore, a redundant description of the same configuration will be omitted.

The vent structure 50 may extend a predetermined length in the width direction (x-axis direction) of the cap plate 21. The vent structure 50 may have a major axis direction corresponding to a longitudinal direction thereof and a minor axis direction corresponding to a width direction thereof. The major axis direction may correspond to a direction intersecting the longitudinal direction (y-axis direction) of the cap plate 21. Particularly, the major axis direction may be formed perpendicular to the longitudinal direction (y-axis direction) of the cap plate 21, and the minor axis direction may be formed parallel to the longitudinal direction (y-axis direction) of the cap plate 21.

The vent structure 50 has a major axis X11 and a minor axis X12. The major axis X11 refers to a longest line segment that passes through a center of the vent structure 50 and connects outer edges of the vent structure 50. The major axis X11 may extend in a direction intersecting a longitudinal direction of the cap plate 21. In addition, the major axis X11 may extend in a direction perpendicular to the longitudinal direction of the cap plate 21, that is, in a width direction of the cap plate 21. However, the present disclosure is not limited thereto, and the major axis X11 may be obliquely oriented with respect to the longitudinal direction of the cap plate 21.

The minor axis X12 may refer to a longest line segment that connects outer edges of the vent structure 50 and extends in the longitudinal direction of the cap plate 21. The minor axis X12 may pass through the center of the vent structure 50 and connect the outer edges of the vent structure 50, and may be perpendicular to the major axis X11.

The major axis X11 may be formed longer than the minor axis X12. The major axis X11 may have a length that ranges from 1.2 times to 3.5 times that of the minor axis X12.

The major axis X11 may extend in the longitudinal direction of the vent structure 50 and in the width direction of the cap plate 21. The minor axis X12 may extend in the width direction of the vent structure 50 and in the longitudinal direction of the cap plate 21.

In the present description, the length of the major axis X11 may refer to a length of the vent structure 50 that is exposed to the outside through the vent hole H2. The major axis X11 may intersect the longitudinal direction of the cap plate 21. In addition, the major axis X11 may be formed perpendicular to the longitudinal direction of the cap plate 21.

When the cap plate 21 length is defined as L11, the cap plate 21 width is defined as L12, the major axis X11 length, which is the longest line segment that is in the vent structure and extends in the width direction of the cap plate 21, is defined as L21, and a the minor axis X12 length, which is the longest line segment that is in the vent structure and extends in the longitudinal direction of the cap plate 21, is defined as L22, the following equation may be satisfied:

$$\frac{L 22}{L 11} = AL \times \frac{L 21}{L 12} \qquad ( Equation 1 )$$

Here, AL may be a constant satisfying 0.08≤AL≤0.36.

When Equation 1 is satisfied, not only may a fracture pressure of the vent structure 50 be precisely set, but scattering materials such as gas may also be rapidly discharged when the vent structure 50 opens. In addition, a sufficiently large space below the vent structure 50 may be secured, thereby increasing a distance between the electrode tabs.

The electrode assembly 10 has a structure in which the separator 13 is stacked between the positive electrode 11 and the negative electrode 12 each having a plate shape. The positive electrode 11 having a plate shape includes two positive electrode tabs 15, and the negative electrode 12 having a plate shape includes two negative electrode tabs 16. The positive electrode tabs 15 may be spaced apart from each other in the longitudinal direction of the cap plate 21. The negative electrode tabs 16 may also be spaced apart from each other in the longitudinal direction of the cap plate 21. A distance L31 between the positive electrode tabs 15 may be greater than the maximum width (corresponding to the length L22 of the minor axis X12) of the vent structure 50.

More specifically, when a distance between the positive electrode tabs 15 located on each positive electrode 11 is defined as L31, the distance L31 between the positive electrode tabs 15 may satisfy the following equation:

$$L 31 = BL \times L 22 \qquad ( Equation 2 )$$

Here, BL may be a constant satisfying 1.2≤BL≤6.5.

When Equation 2 is satisfied, heat generated between the tabs, on which current is concentrated, may be rapidly dissipated, and problems such as an increase in temperature due to heat generation may be prevented.

The vent structure 50 may include two side notches 52 and 53 and a connection notch 51 that connects the side notches 52 and 53. Each of the connection notch 51 and the side notches 52 and 53 may be formed as an elongated groove, and may be formed as a groove having a trapezoidal longitudinal-sectional shape. However, the present disclosure is not limited thereto, and each of the connection notch 51 and the side notches 52 and 53 may have various longitudinal-sectional shapes such as a triangular shape, or an arc shape.

Furthermore, the connection notch 51 and the side notches 52 and 53 may be fractured at a preset pressure. The connection notch 51 may include a first curved line 51a and a second curved line 51b that are formed of curves. The first curved line 51a and the second curved line 51b may be formed in an arc shape, and may protrude convexly in different directions.

The first curved line 51a may protrude convexly toward one side edge of the vent structure 50 (in a y-axis direction), and the second curved line 51b may protrude convexly toward another side edge of the vent structure 50 (in a-y-axis direction). Accordingly, the first curved line 51a and the second curved line 51b may protrude convexly in opposite directions to form a wave shape or an S-shape.

Here, an inflection point CP1 at which the first curved line 51a and the second curved line 51b meet may be formed at a center in a longitudinal direction (x-axis direction) of the connection notch 51. In addition, the first curved line 51a and the second curved line 51b may have the same curvature radius. For example, the first curved line 51a and the second curved line 51b may be formed to have a first curvature radius R11. Accordingly, the connection notch 51 may be formed in point symmetry with respect to the inflection point CP1.

Here, a length of the connection notch 51 may range from 0.9 times to 1.3 times the length L21 of the major axis X11. In addition, the length of the connection notch 51 may be greater than the length L21 of the major axis X11. For example, the length of the connection notch 51 may range from 1.01 times to 1.3 times the length L21 of the major axis X11.

The two side notches 52 and 53 may be formed to protrude convexly in opposite directions, protruding convexly outward in the longitudinal direction (x-axis direction) of the vent structure 50. The connection notch 51 is connected to the first side notch 52 and the second side notch 53. The first side notch 52 and the second side notch 53 may have the same structure and be arranged in line symmetry.

The first side notch 52 may include a curved portion 52a that is curved in an arc shape, a first linear portion 52b that is connected to one end of the curved portion 52a and extends linearly, and a second linear portion 52c that is connected to a remaining end of the curved portion 52a and extends linearly.

The first linear portion 52b and the second linear portion 52c may extend in the width direction (x-axis direction) of the cap plate 21, and may be arranged parallel to each other. The curved portion 52a is formed in an arc having a second curvature radius R12 and is configured to partially enclose the connection notch 51.

The second side notch 53 may include a curved portion 53a that is curved in an arc shape, a first linear portion 53b that is connected to one end of the curved portion 53a and extends linearly, and a second linear portion 53c that is connected to a remaining end of the curved portion 53a and extends linearly. Furthermore, the connection notch 51 may be connected to longitudinal central portions of the first side notch 52 and the second side notch 53.

The first side notch 52 and the second side notch 53 may be spaced apart from each other by a distance, and may be formed to partially enclose the connection notch 51. Here, the first side notch 52 and the second side notch 53 may enclose 50% to 90% of the connection notch 51.

The first side notch 52 and the second side notch 53 may have the same length. The length of each of the side notches 52 and 53 may be formed longer than a length of the connection notch 51. The length of each of the side notches 52 and 53 may range from 1.02 times to 1.27 times the length of the connection notch 51. For example, the length of the connection notch 51 may range from 18 mm to 55 mm, and the length of each of the side notches 52 and 53 may range from 19 mm to 60 mm.

In the case where the lengths of the side notches 52 and 53 ranges from 1.02 times to 1.27 times the length of the connection notch 51, the connection notch 51 may fracture first, or the side notches 52 and 53 may fracture first. When the side notches 52 and 53 fracture first, two openings may be formed. When the connection notch 51 fractures first, two pieces may be bent upward to form a single opening.

In addition, when the length of the connection notch 51 is defined as L41 and the length of each of the side notches 52 and 53 is defined as L42, the following equation may be satisfied:

$$L 41 + 2 \times L 42 = DL \times L 21 \qquad ( Equation 3 )$$

Here, L21 denotes a maximum length of the vent structure, and DL may be a constant satisfying 2.5≤DL≤6.5.

With reference to FIG. 33, a first distance G11, which is a maximum distance between the major axis X11 and the connection notch 51, may range from 0.05 times to 0.4 times a second distance G12, which is a maximum distance between the major axis X11 and the first side notch 52. The first curvature radius may be referred to as R11 and the second curvature radius may be referred to as R12. A first distance that is a maximum distance between a virtual reference line extending in a longitudinal direction of the vent structure and the connection notch is defined as G11. The vent structure may satisfy Equation 4 as follows:

$$R 11 = A \times R 12 + G 11 \qquad ( Equation 4 )$$

Here, A may be a constant satisfying 1.3≤A≤4.5.

FIG. 34 is a plan view illustrating a secondary battery according to a fifteenth aspect of the present disclosure.

Referring to FIG. 34, a secondary battery 102 according to the fifteenth aspect has the same structure as the secondary battery according to the fourteenth aspect, except for a vent structure 140; therefore, a redundant description of the same configuration will be omitted.

The secondary battery 102 may be configured as a prismatic battery having a casing 30 with a substantially rectangular pillar shape. The vent structure 140 may be fixed to a cap plate 21. A bottom 35 of the casing 30 may be integrally formed with the casing 30 or may be fixed to the casing 30 by welding or the like.

The vent structure 140 may be formed in a plate shape and may be fixed to the cap plate 21 by welding. A longitudinal direction of the vent structure 140 may be oriented obliquely with respect to a longitudinal direction of the cap plate 21. The vent structure 140 has a major axis X11 and a minor axis X12. The major axis X11 refers to a longest line that passes through a center of the vent structure 140 and connects outer edges thereof. The minor axis X12 refers to a line that passes through the center of the vent structure 140 and connects outer edges thereof, and is perpendicular to the major axis X11.

While the present disclosure has been described with respect to the specific aspects, it will be apparent to those skilled in the art that various changes or modifications of the present disclosure are possible by adding, changing, or deleting components without departing from the spirit of the present disclosure as defined in the following claims. It should be noted that these changes or modifications also fall within the bounds of the present disclosure.

What is claimed is:

1. A secondary battery, comprising:
a casing including;
an electrode assembly accommodated in the casing;
a cap plate coupled to the casing; and
a vent structure located along the casing or the cap plate,
wherein the vent structure includes a plurality of lateral scores and a connection score connecting the lateral scores, and wherein the connection score includes at least one curved line following a curved path along a length direction of the connection score, and
wherein at least one lateral score of the plurality of lateral scores includes a curved portion along a length direction of the at least one lateral score.

2. The secondary battery according to claim 1, wherein the curved line extends in an arc shape having a first curvature radius, and the curved portion of the at least one lateral score defines an arc shape having a second curvature radius.

3. The secondary battery according to claim 2, wherein the first curvature radius is different from the second curvature radius.

4. The secondary battery according to claim 2, wherein the first curvature radius is greater than the second curvature radius.

5. The secondary battery according to claim 2, wherein the first curvature radius is 1.1 times to 5.5 times the second curvature radius.

6. The secondary battery according to claim 2, wherein the at least one lateral score includes a first linear portion connected to a first end of the curved portion and extending in a straight line, and a second linear portion connected to a second end of the curved portion and extending in a straight line.

7. The secondary battery according to claim 1, wherein the at least one curved line includes a first curved line and a second curved line, and the first curved line and the second curved line are bowed out in opposing directions.

8. The secondary battery according to claim 7, wherein a curvature radius of the first curved line equals a curvature radius of the second curved line.

9. The secondary battery according to claim 7,
wherein the connection score has an inflection point at which the first curved line and the second curved line meet, and
wherein an inclination angle of an acute angle defined between a tangent line at the inflection point and a longitudinal axis the vent structure ranges from 5 degrees to 60 degrees.

10. The secondary battery according to claim 1, wherein a first distance that is a maximum distance between the connection score and a longitudinal axis of the vent structure is 0.05 times to 0.4 times a second distance that is a maximum distance between the longitudinal axis and the lateral scores.

11. The secondary battery according to claim 1, wherein the plurality of lateral scores includes a first lateral score and a second lateral score, and the first lateral score and the second lateral score surround from 50% to 90% of the connection score.

12. The secondary battery according to claim 1, wherein the vent structure include an elongated protrusion extending longitudinally along the connection score and protruding convexly from the vent structure, and the connection score is positioned on the elongated protrusion.

13. The secondary battery according to claim 1, wherein the vent structure includes elongated protrusions extending longitudinally along respective lateral scores and protruding convexly from the vent structure, and the lateral scores are positioned on the respective elongated protrusions.

14. The secondary battery according to claim 1, wherein the vent structure includes a first elongated groove extending longitudinally along the connection score and recessed in a concave shape within the vent structure, and second elongated grooves extending longitudinally along the respective lateral scores and recessed in a concave shape within the vent structure, the connection score is positioned in the first elongated groove, and the lateral scores are positioned in the respective second elongated grooves.

15. The secondary battery according to claim 1,
wherein the vent structure includes a first recess encompassing the lateral scores and the connection score, and a second recess positioned in a bottom of the first recess and extending longitudinally along the connection score, and
wherein the lateral scores are positioned in the first recess, and the connection score is positioned in the second recess.

16. The secondary battery according to claim 1, wherein the vent structure is located in the cap plate, a bottom surface of the casing, or a side surface of the casing.

17. The secondary battery according to claim 1, wherein the curved line includes a plurality of curvature radii.

18. The secondary battery according to claim 1, wherein a longitudinal axis of the vent structure extends parallel to a longitudinal direction of the cap plate.

19. The secondary battery according to claim 1, wherein a longitudinal axis of the vent structure extends in a direction intersecting a longitudinal direction of the cap plate.

20. The secondary battery according to claim 1,
wherein the vent structure includes a first convex portion and a second convex portion that are disposed adjacent to each other and protrude outward from the vent structure, and
the connection score is located between the first convex portion and the second convex portion.

21. The secondary battery according to claim 20, wherein an inclination angle formed between a tangent line of the first convex portion or the second convex portion where the convex portion connects to the connection score and a plane parallel to the cap plate is in a range from 1 degree to 20 degrees.

22. The secondary battery according to claim 20, wherein a first tangential angle formed between a first tangent line at an edge of the first convex portion adjacent to the connection score and a virtual reference plane parallel to the cap plate is smaller than a second tangential angle formed between a second tangent line at an edge of the first convex portion adjacent to one of the plurality of lateral scores and the virtual reference plane.

23. The secondary battery according to claim 22, wherein the second tangential angle ranges from 1.1 times to 3.5 times the first tangential angle.

24. The secondary battery according to claim 20,
wherein the connection score includes an inflection point at which the first curved line and the second curved line meet, a first reference point at which the first curved line forms a maximum distance from a reference line extending in a longitudinal direction of the vent structure at a center in a width direction of the vent structure, and a second reference point at which the second curved line forms a maximum distance from the reference line, and
wherein a first inclination angle formed between a tangent line at an outer edge of the first convex portion in the width direction at the first reference point and a virtual reference plane parallel to the cap plate, and a second inclination angle formed between a tangent line at an outer edge of the first convex portion in the width direction at the second reference point and the reference plane, are each greater than a third inclination angle formed between a tangent line at an outer edge of the first convex portion in the width direction at the inflection point and the reference plane.

25. The secondary battery according to claim 24, wherein the first inclination angle and the second inclination angle are each in a range of from 1.2 times to 2.5 times the third inclination angle.

26. The secondary battery according to claim 20, wherein the connection score, the plurality of lateral scores, the first convex portion, and the second convex portion are formed on an outer surface of the vent structure that faces away from an outer side of the casing.

27. The secondary battery according to claim 20, wherein the connection score, the plurality of lateral scores, the first convex portion, and the second convex portion are formed on an inner surface of the vent structure that faces inside the casing.

28. The secondary battery according to claim 20, wherein the first convex portion and the second convex portion are formed on an outer surface of the vent structure that faces away from an outer side of the casing, and the connection score and the plurality of lateral scores are formed on an opposite inner surface of the vent structure that faces inside the casing.

29. The secondary battery according to claim 20, wherein the first convex portion and the second convex portion are formed on an inner surface of the vent structure that faces inside the casing, and the connection score and the plurality of lateral scores are formed on an opposite outer surface of the vent structure that faces away from an outer side of the casing.

30. The secondary battery according to claim 20, wherein the vent structure further comprises a support rib protruding from a position outside each of the plurality of lateral scores and surrounding the corresponding lateral score.
